(19) United States
(12) Patent Application Publication
(10) Pub. No.: US 2020/0311635 A1
(43) Pub. Date: Oct. 1, 2020

(54) PROVIDING PHYSICAL SPACES, RESOURCES, AND INFORMATION TO USERS AND MANAGERS WITHIN A WORKSPACE, SUCH AS VIA A MEMBER APP

(71) Applicant: WeWork Companies LLC, New York, NY (US)

(72) Inventors: Joshua James Emig, Cold Springs, NY (US); Andy Palmer, New York, NY (US); Shiva Rajaraman, Burlingame, CA (US)

(21) Appl. No.: 16/833,278

(22) Filed: Mar. 27, 2020

Related U.S. Application Data
(60) Provisional application No. 62/826,898, filed on Mar. 29, 2019.

(51) Int. Cl. G06Q 10/06

(52) U.S. Cl. CPC G06Q 10/06313

(57) ABSTRACT

The following description describes a member application, member experiences, and resources for a manager of a coworking location. The follow description provides details on the following: 1) techniques for identifying open rooms, and conference room reservation and optimization, 2) guest registration systems and processes, 3) occupancy and insights/analytics for a co-working space, 4) map editing based on members and community teams within a space, 5) intelligent and automatic booking of conference rooms and other resources, 6) event planning engines to permit automatic and efficient posting or publication of events within a co-working space, 7) announcement planning engines to automatically produce announcements and posters for events, 8) wayfinding and reservations for phone booths and other typically non-registrable resources, 9) wayfinding and member discovery.

### CROSS-REFERENCE TO RELATED APPLICATIONS

This application claims priority to U.S. Provisional Patent Application No. 62/826,898, filed on Mar. 29, 2019, the entire contents of which are incorporated herein by reference in its entirety.

### BACKGROUND

Many workers in service or other industries typically use or need an office in which to work, which often takes the form of thousands of square feet of office space leased or owned by the worker's employer. Some workers are self-employed or work for small companies that may have a more difficult time finding an acceptable space in which to work. These self-employed or small company workers—as well as workers for large businesses—have turned to coworking arrangements.

Coworking is a self-directed, collaborative, and flexible work style, often based around a common interest, such as geographic location, shared social values, etc. Coworking typically employs a shared workplace and independent activities among individuals working with the workplace. Unlike a typical office, coworking often allows workers from different organizations to share resources such as conference rooms, break rooms, receptionists, IT professionals, telecommunications resources, etc. Coworking workers are relieved of the effort of finding, renting, outfitting, supplying, and managing their own space.

Coworking arrangements are attractive to work-at-home professionals, independent contractors, independent scientists, and people who travel frequently—typically workers who would otherwise end up working in relative isolation (though coworking is in no way limited to such workers). Coworkers can enjoy a social gathering of a group of people who are still working independently, but who may share certain values and who are interested in the synergy that can happen from working with people who value working in the same place alongside each other. Coworking offers a solution to the problem of isolation that many freelancers experience while working at home, while at the same time letting them escape the distractions of home. Moreover, some larger businesses see the value in offering coworking arrangements for some of their employees who can enjoy the same benefits noted above, even if a large number of them represent a majority of other workers sharing a common workspace.

### BRIEF DESCRIPTION OF THE DRAWINGS

FIG. 1 is a partial schematic, partial block diagram of a coworking space.

FIG. 2 is a block diagram of a representative mobile device that can display various GUI screens.

FIGS. 3A-22B are display diagrams illustrating examples of GUI screens for display on a mobile device, computer or other data processing platform.

FIG. 23 is a flowchart of a method to reduce traffic congestion and greenhouse gas emissions.

FIG. 24 is a flowchart of a method to enable a user to reserve a meeting room.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Described in detail below are systems and methods for allocating multiple resources to users of, and managers within, a co-working facility, and others involved in the supply or consumption of resources within a workspace. The following description describes a member application (member app), member experiences, and resources for a manager of a coworking location (a community manager). The follow description provides details on the following: 1) techniques for identifying open rooms, and conference room reservation and optimization, 2) guest registration systems and processes, 3) occupancy and insights/analytics for a co-working space, 4) map editing based on members and community teams within a space, 5) intelligent and automatic booking of conference rooms and other resources, 6) event planning engines to permit automatic and efficient posting or publication of events within a co-working space, 7) announcement planning engines to automatically produce announcements and posters for events, 8) wayfinding and reservations for phone booths and other typically non-registrable resources, 9) wayfinding and member discovery (Spacewalk), 10) efficient parking management, 11) printing systems, 12) automated food/beverage delivery, and 13) keycard registration. While the various systems and methods are described herein as applied to a co-working facility, the systems and methods are equally applicable to many other environments and are in no way limited to co-working environments.

At times, the terms “facility” and “location” are used interchangeably herein; likewise, the terms “member” and “user” are used interchangeably herein. A member or user can be an employee of a third-party company that leases space within the co-working facility or location, though a member can be a sole proprietor. A “community manager” (CM) is a representative of the organization that manages and often leases space to members within a co-working facility. The CM is effectively an office manager for all of the different companies and members within a building, floor of the building, or portion of a floor within a building. A “community team” includes not only the CM but also other representatives of the organization offering the co-working space to third parties, and can include IT professionals, janitorial employees, security personnel, etc.

In the following description, for the purposes of explanation, numerous specific details are set forth in order to provide a thorough understanding of implementations of the present technology. It will be apparent, however, to one skilled in the art that implementations of the present technology can be practiced without some of these specific details.

The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

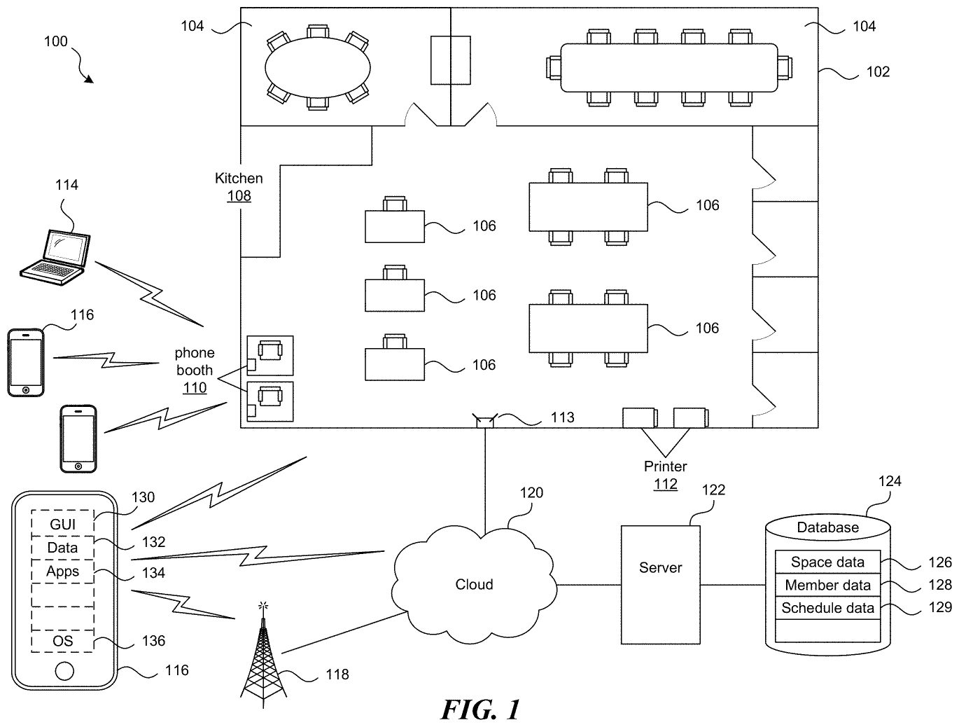

Several implementations are discussed below in more detail with reference to the figures. FIG. 1 illustrates an overview of an environment 100 in which some implementations of the disclosed technology can operate. Environment 100 includes a co-working facility 102 that includes conference rooms 104, desks 106 and a kitchen area 108. The co-working facility also includes additional resources such as phone booths 110 and printers 112, as well as IT infrastructures such as wireless routers 113 to provide wireless local networking (e.g. IEEE 802.11 WiFi networking), networked or “smart” thermostats, smart lighting, and so forth.

Members who use the co-working facility 102 typically have one or more laptop computers 114, mobile phones 116, and other data processing devices that can connect to one or more servers 122 via the wireless routers 113 or via WWAN/cellular base stations 118 and via a network or cloud 120. The server 122 is coupled to one or more databases 124. The database 124 stores data such as space data 126, member data 128 and schedule data 129. The space data 126 includes data related to physical layout and resources within the co-working facility 102. The member data 128 includes information regarding members who work within the facility 102, and can include information regarding rental or lease data, personal information, preferences, and so forth. The schedule data 129 includes information regarding scheduling of resources within the facility 102, such as the conference rooms 104, desks 106, and so forth.

As described below, each member can access or schedule resources within the facility 102 or elsewhere via one or more applications running on the laptop 114 or mobile device 116. As shown, the mobile device can include an operating system 136, one or more applications 134, application data 132 and a graphical user interface (GUI) 130.

While server 122 is displayed logically as a single server 122, the system can employ a distributed computing environment encompassing multiple computing devices located at the same or at geographically disparate physical locations. In some implementations, each server 122 can correspond to a group of servers.

Network or cloud 120 can be any network, ranging from a wired or wireless local area network (LAN), to a wired or wireless wide area network (WAN), to the Internet or some other public or private network. While the connections between the server 122 and the loud 120 and database 124 are shown as separate connections, these connections can be any kind of local, wide area, wired, or wireless network, public or private.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

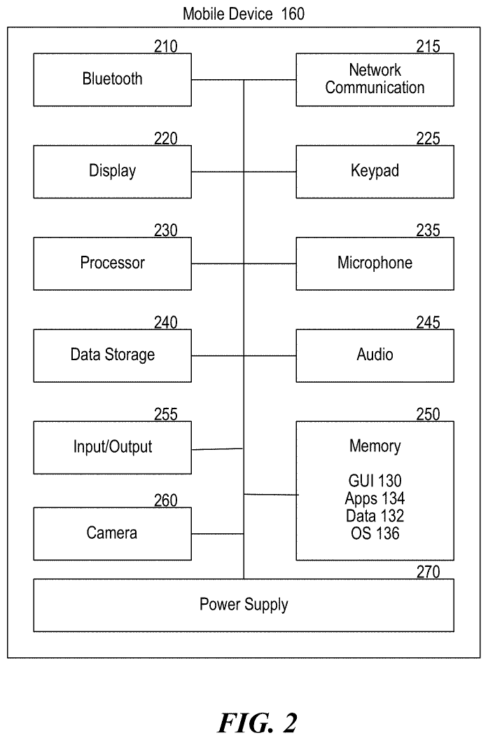

FIG. 2 is a block diagram of a representative mobile device 116 that may serve as a handset on which a member app operates in accordance with embodiments herein, though much of the same components apply equally to laptop 114. Mobile device 116 typically includes a processor 230 for executing processing instructions, a data storage medium component 240 (e.g., hard drive, flash memory, memory card, etc.), volatile memory and/or nonvolatile memory 250, a power supply 270, one or more network interfaces (e.g., Bluetooth Interface 210 or Network Communication Interface 215, which enables the mobile phone to communicate by transmitting and receiving wireless signals using licensed, semi-licensed or unlicensed spectrum over a telecommunications network), an audio interface 245, a display 220, a keypad or keyboard 225, a microphone 235, one or more cameras 260, and other input and/or output interfaces 255. The various components of the mobile device may be interconnected via a bus. The volatile and nonvolatile memories generally include storage media for storing information such as processor-readable instructions, data structures, program modules, or other data. The stored information includes instructions, which when executed by the processor 230, perform operations for performing the functions as described in detail below.

Mobile device 116 may be virtually any device for communicating over a wireless network. Such devices include application servers or mobile telephones, Personal Digital Assistants (“PDAs”), radio frequency devices, infrared devices, handheld computers, laptop computers, wearable computers, tablet computers, pagers, smart watches, integrated devices combining one or more of the preceding devices, and/or the like.

### Meetings and Room/Resource Booking

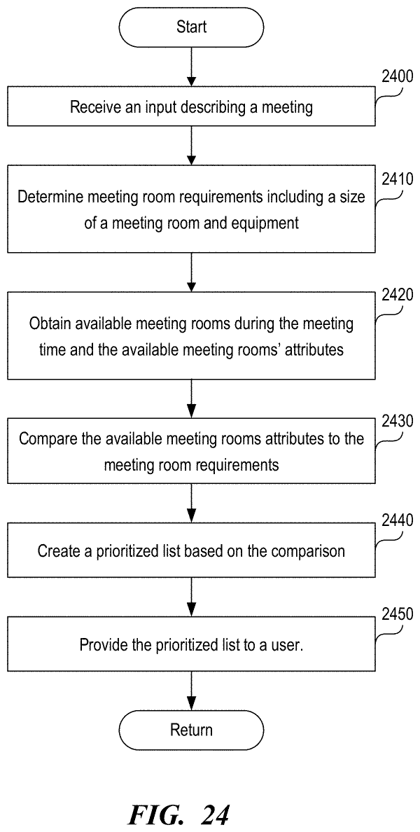

A coworker or member may require a conference room, facility or other resource. As described in detail herein, a software application, running on a member mobile device, allows that member to reserve, book or schedule a conference room for a meeting or other resource. Considering the example of booking a room, the software application or “booking app” in the member app allows members to effectively search for a suitable room by viewing and filtering among multiple rooms that would provide results matching that member's preferences. The booking app can perform the steps described in FIG. 24 below.

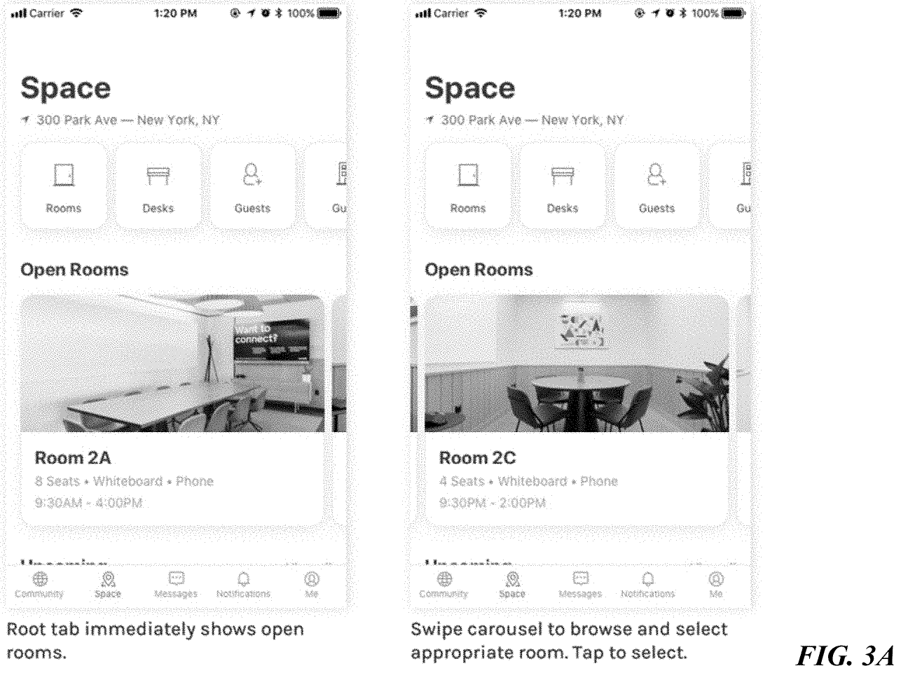

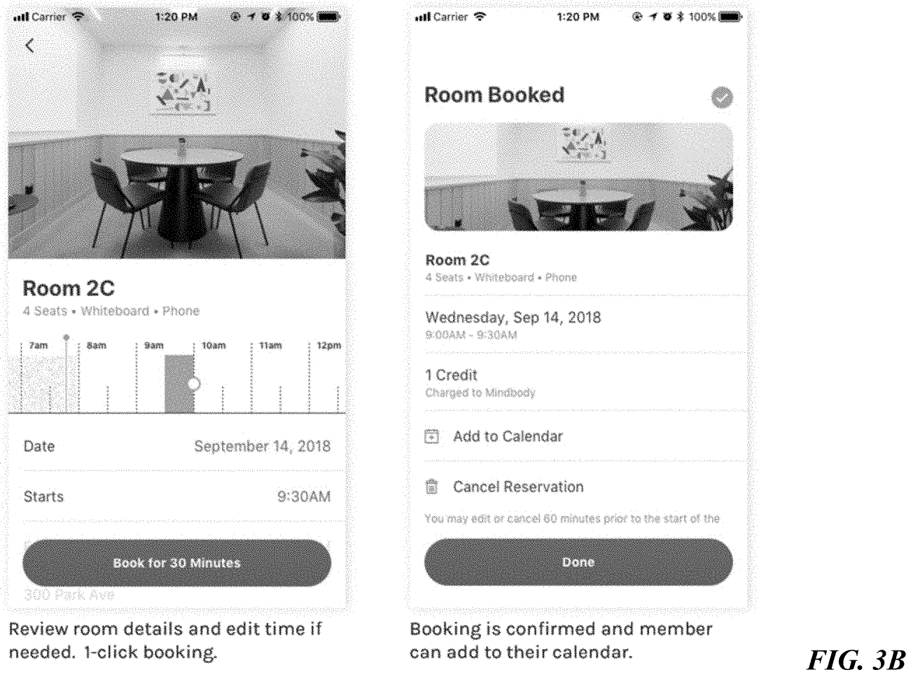

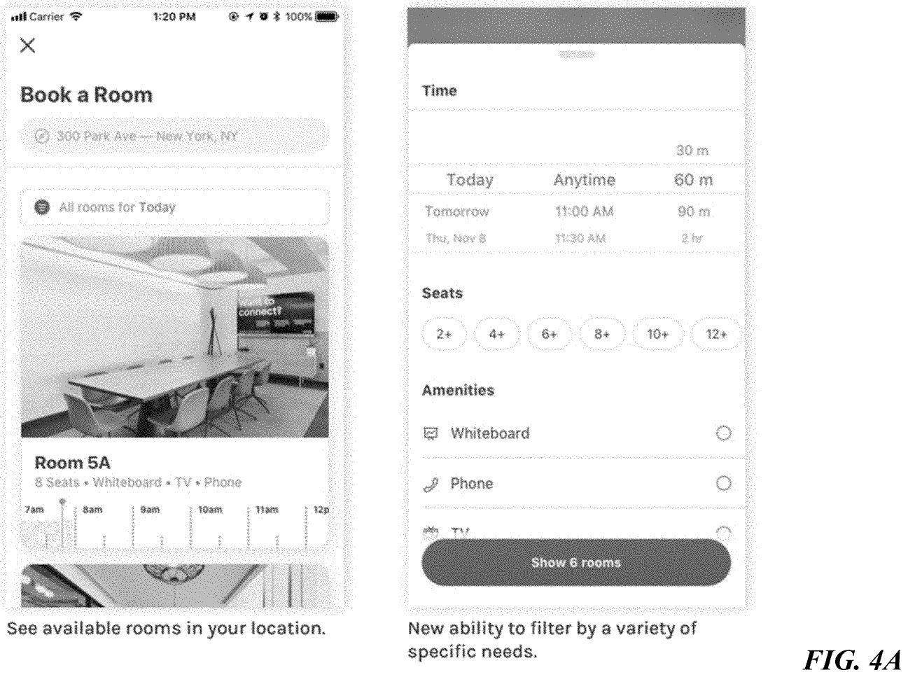

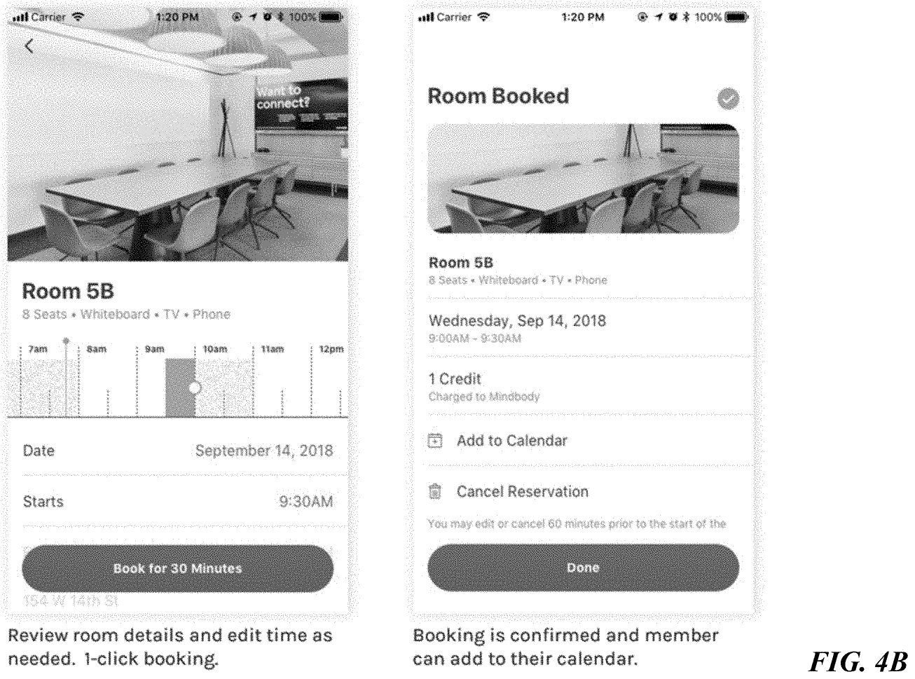

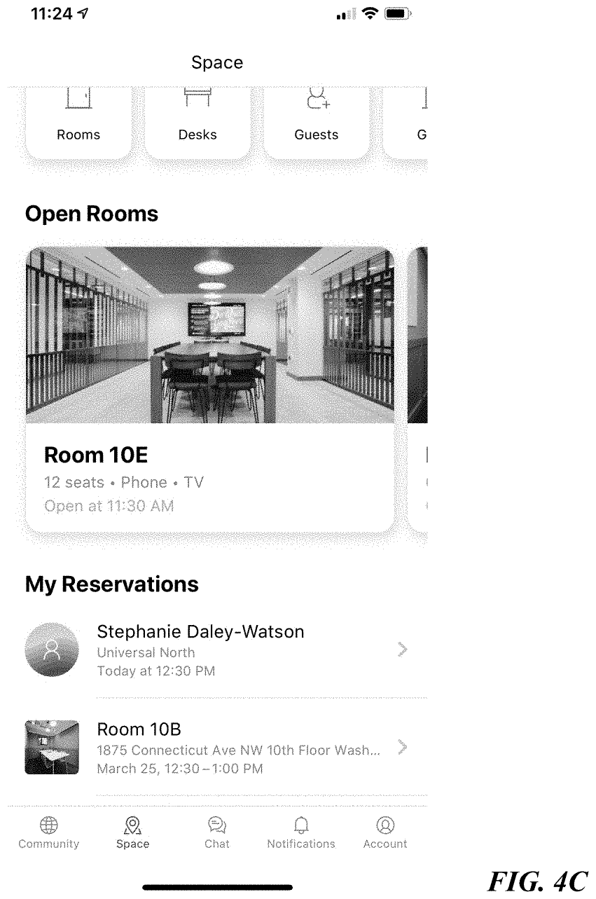

Referring to FIGS. 3A-3B and 4A-4C, FIG. 3A shows two display screens that allow a user to, via the member app, horizontally swipe through images of available conference rooms to book, along with details regarding those rooms such as the number of seats, resources available (whiteboard, phone, printer, television), and time during which the room is available. The screens shown in FIG. 3A are displayed when a user selects the “Space” button in the lower horizontal series of displayed icons. As shown in the depicted screens, not only can users reserve or book a room, but they can also book a desk, identify a number of guests, and so forth.

FIG. 3B shows how a user can book a room for 30 minutes with a single action or button click, and then be displayed a confirmation screen providing details on the reserved room, with the option to add that meeting to the member's calendar or to cancel the reservation. When reserving the room, the GUI displays a linear timeline divided into 30 minute intervals, and the user can adjust the reservation time to be greater than 30 minutes by selecting a depicted circle at the end time and extending it rightward.

As shown in the right-hand screen in FIG. 3B, once a user or member requests to book a room, the system provides back to the user's mobile device a booking confirmation screen, confirming the room booked, the date and time, and the number of credits or points deducted from the user's account for the room reservation. From the screen, the user can add the meeting to the user's calendar, cancel the reservation, invite guests (see below), or edit the reservation.

FIG. 4A is an alternative implementation where the user can swipe vertically to see a picture of available rooms and below each room a timeline identifying available times for that room. Alternatively, the user can select a filter for available rooms that meet certain criteria. For example, the user can use scroll wheels to identify rooms available on a given day, with a given starting time, and for a given duration. Other criteria to filter include number of seats in the room, and amenities available such as whiteboard, phone, TV, etc. Once filters are selected, the member app then shows only those rooms meeting the user selected/filtered criteria. Thereafter, as shown in FIG. 4B, the user can book the room and then receive a confirmation.

FIG. 4C shows to the member the meeting rooms reserved for the member, the times for which the meeting rooms were booked, and equipment in the meeting rooms. In addition, a visual representation, such as a photograph, a virtual tour, or a 3D model, of the room can be shown to the member to aid the member in identifying the room once the member is in the building.

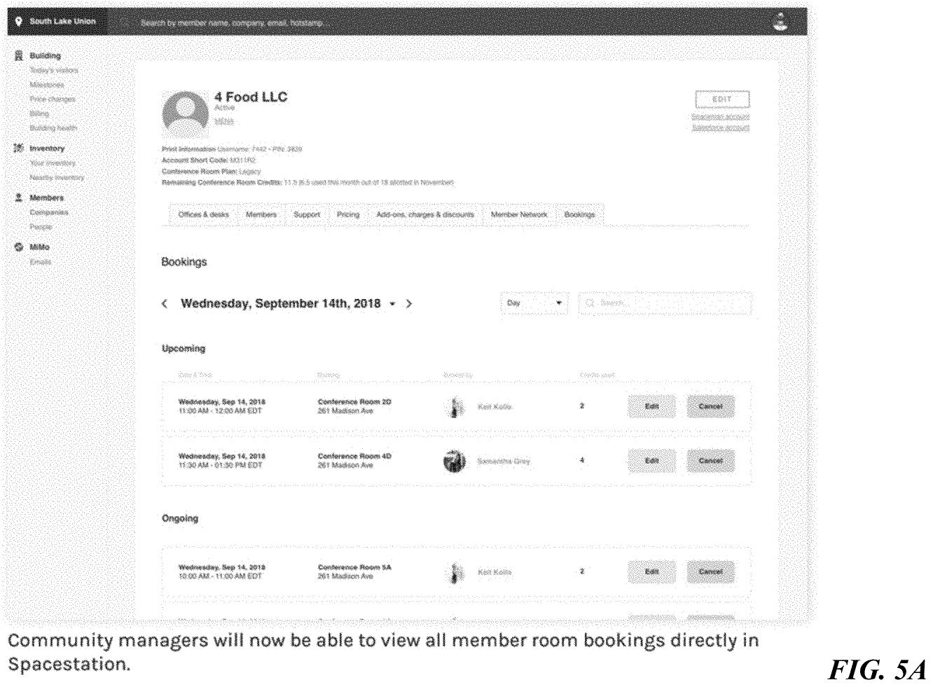

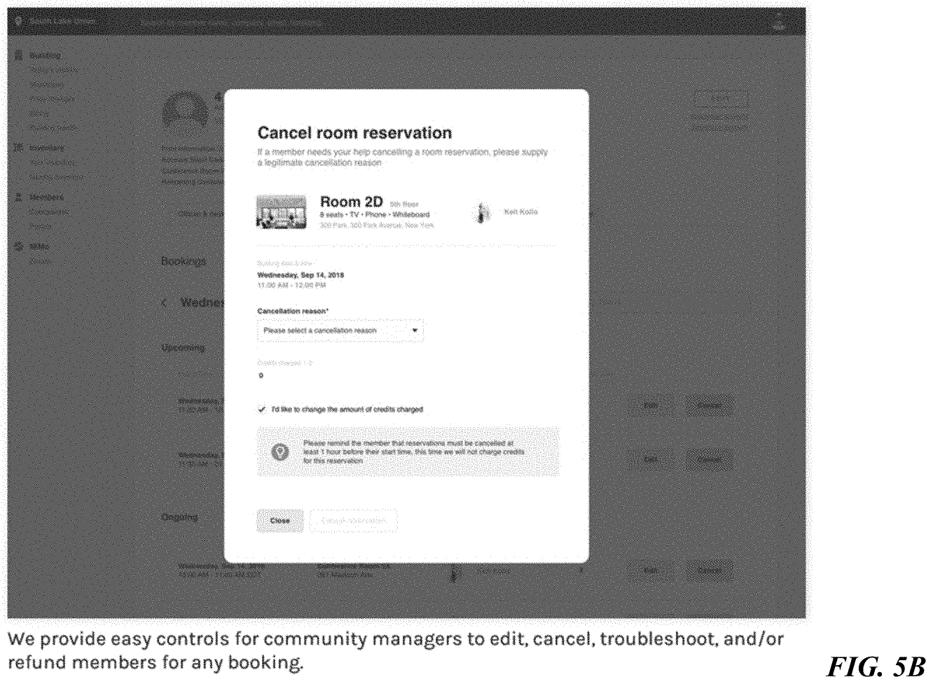

Referring to FIG. 5A, a display screen to be displayed on, for example, a laptop or computer, is provided to a manager of the facility 102, such as a “community manager” or CM. This screen shows all of the conference rooms booked within the facility, the times of their bookings, the particular conference rooms, and who booked those rooms. In this way, community managers are able to view all member room bookings directly within one screen via one application, shown as “Spacestation.” The community manager can edit the scheduled conference rooms or cancel them via this interface.

As shown in FIG. 5B, if the community manager cancels a reserved room, the manager can select a reason, and determine whether any fee or credits are to be assessed against the member for canceling the room. This interface allows the community manager to edit, cancel, troubleshoot, and/or refund members for any booked rooms. While described herein as related to booking or scheduling conference rooms, the functions and interfaces described herein apply equally to reserving, canceling, editing and troubleshooting any resources provided to users within the environment 100 or facility 102.

The booking app can prioritize certain features of a given room based on items such as availability of audiovisual equipment (AV), temperature of the room, and acoustics for the room (quiet or bright), thereby placing them at the top of the displayed GUI.

The booking app is configured for enabling members to more easily home in on a room that has the right fit based on specific criteria, and/or smartly recommending rooms that members can quickly re-book.

### Guests Registration

Members want their guests to have a seamless and pleasant check-in experience when they arrive at a co-working facility, but some members may not register their guests because guest registration processes can be cumbersome, time-consuming, and error-prone. All members should register guests, both to help keep facilities secure and to facilitate access for their guests when they arrive at the facility.

Guests who arrive at a facility without being registered beforehand can be exposed to a lengthy and confusing check-in process. Security issues can also arise in identifying and prohibiting known banned people from buildings. Security issues, along with generally managing guest inflow (especially unregistered guests), also add additional effort, requiring community managers to play a policing role rather than a relationship building role.

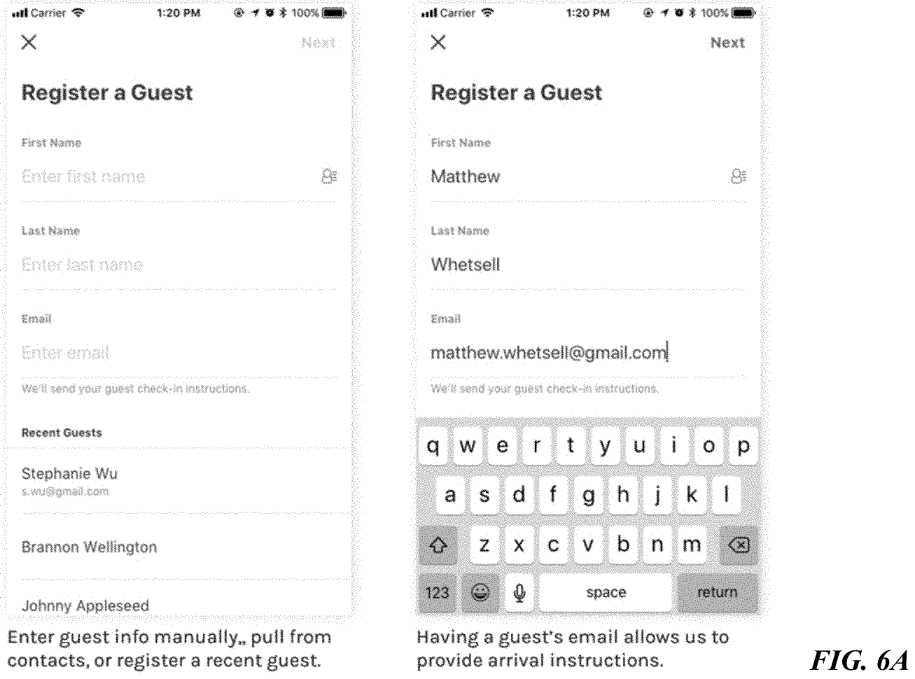

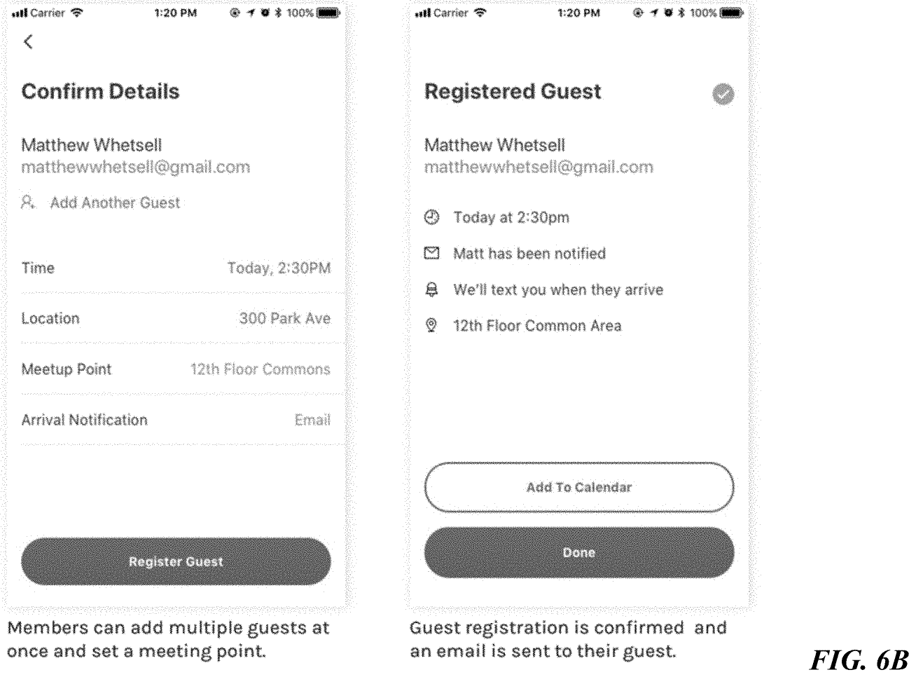

Referring to FIG. 6A, a GUI screen displayable by the member app allows a user to enter a guests name and email address, as well as providing recent guests from which the user can quickly select to add as guests to register for a new meeting. The member app can pull guest data locally from the user's address book stored on the mobile device or stored remotely. By providing an email address, the server 122 can provide an email to that guest that provides information regarding the facility 102, such as location, parking, security requirements, special instructions regarding nearby construction or road closures, etc.

FIG. 6B shows a GUI screen display to the user confirming registration of a guest, with options to add another guest, as well as changing the time or location of the meeting. Once confirmed, the user receives a confirmation screen as shown, and allows the user to automatically add the meeting to the user's calendar. The confirmation screens can include additional information such as identifying the meeting point for the user and guests, provide a QR code that can be scanned at check-in or at a security desk, and provide a way to manage guest notifications (such as notifications to the guest, as well as notifications to the member, such as communications via email, text, voicemail, etc.).

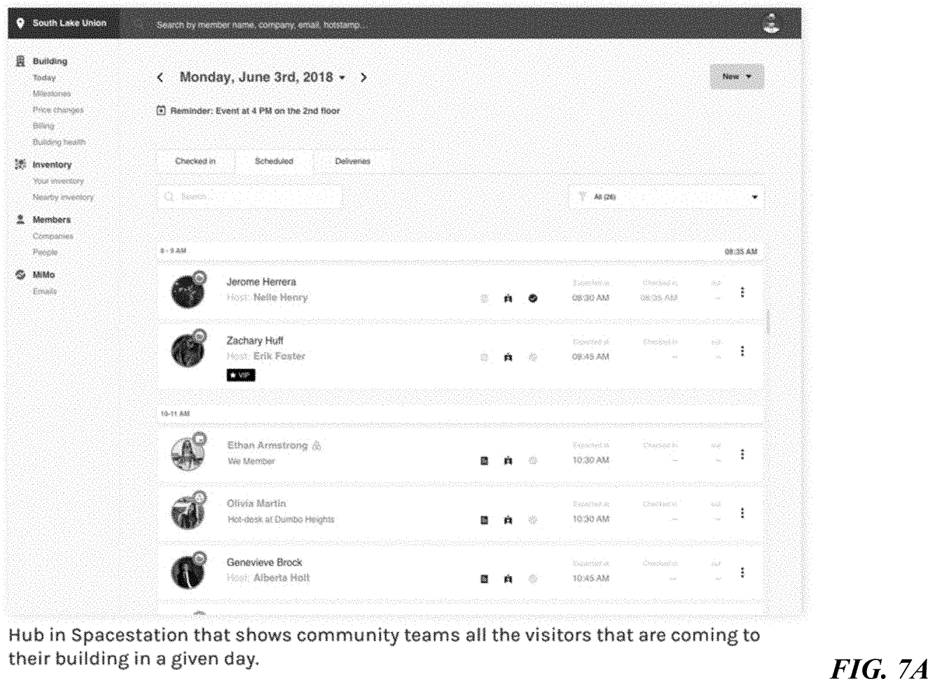

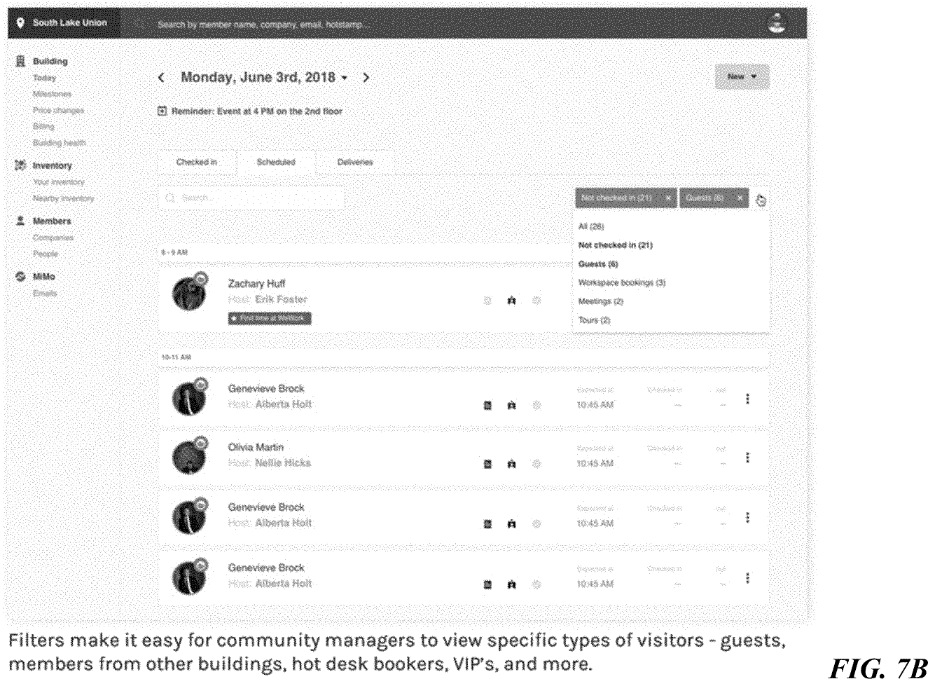

FIG. 7A shows a display screen of a manager app to be displayed on, for example, a laptop or computer, and that is provided to a manager of the facility 102 (a “community manager”). This screen shows all of the guests registered and who are expected to arrive at the facility 102 for a given day. FIG. 7B shows how the manager app provides GUI tools to permit the manager to view specific types of visitors, such as guests of members, members from other buildings, members who book desks, VIPs etc.

Besides providing security and improving registration, the present system can extend some basic services to guests, from basic information about the co-working facility, assistance in wayfinding, connecting to the neighborhood, etc. This also opens up the opportunity to connect guests to partner companies like food or catering companies and understand more about guests and their preferences.

A technological solution for guest registration helps provide a safer environment for members and employees and streamlines secure entry to events. The registration functionality within the member app can also present to guests NDAs that must be executed or confirmed before visiting. Guests can also have access to various services provided by the facility 102 or by the community manager, such as information regarding the neighborhood in which the meeting is to be held (local restaurants in any local partnerships), communications from the community manager regarding social activities for members, etc.

This system will save the amount of time it takes to register guests, get them in the building, and connect with them when they arrive. This system will also help members to be better hosts, which may also help them to ‘maximize their potential’ as a member company.

### Spacewalk: Curated Tours for New Members

It is not immediately clear to members that co-working spaces are created deliberately vague (e.g., lack of physical signage, similar look and feel) to standardize experience and encourage the engagement and collaboration of members (e.g. asking for directions, serendipitous meetings) and foster organic community interaction. However, such vagueness can lead to frustration from members (as well as community teams and visitors), as there is a gap in knowledge and expectations/norms with regard to physical spaces; and can lead to inherent friction in day-to-day usage of physical spaces (initially high, especially during formative weeks and months).

The first few weeks are important to new members, as this is when behavior and patterns start to form. Educating new members on the design decisions that led to different, curated spaces (including where these exist, and how to get there) will help advance their understanding of how best to utilize space.

This heightened awareness can result in optimum usage, enabling better mobility and connection, while reducing anxiety and in turn reducing workload for community teams and allowing them to focus on more important interactions.

The member app includes a curated tour application (“Spacewalk”) that can form one aspect of multiple wayfinding initiatives. The present system can thereby cater to multiple users (e.g. internal staff onboarding, visitor orientation), as well as additional use cases (e.g. external tours of surrounding neighborhoods), and can employ live indoor positioning (e.g. use WiFi or Bluetooth access points/base stations to help guide users via their mobile phones).

Spacewalk allows new members and existing members who transfer location, the ability to optimize orientation within their first few weeks. After completion, the tour can remain as a reference knowledge base within the member app. The present system can, therefore: Improve overall satisfaction with onboarding; reduce the amount of frustration for members unfamiliar with a new location, and reduce the time community managers spend helping people navigate. The system can measure all of these benefits by way of surveys provided in the member app, as well as in-person interviews.

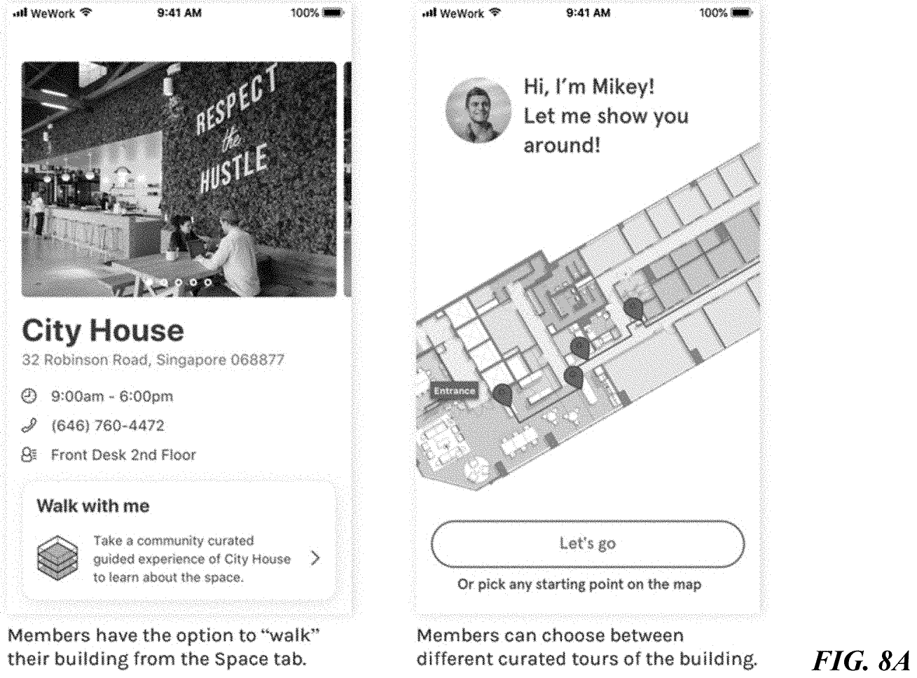

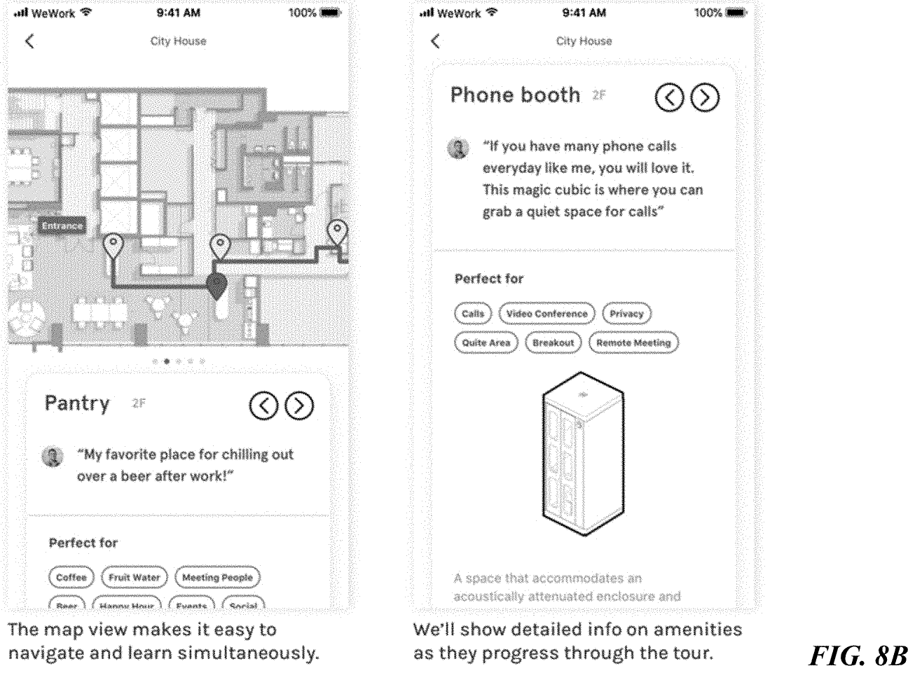

FIG. 8A shows an example of a mobile device GUI provided by the member app that allows members to select a “Walk with me” option to take a community-curated guided tour or experience of a particular co-working facility to learn about that space. Once selected, the member app then provides a GUI that displays a plan view of the space, with a highlighted tour route or line along which the member can walk, with selected waypoints along which the user can select to start the tour.

FIG. 8B shows two examples of the curated tour at waypoints along the tour route, in this case the pantry and a phone booth. The curated tour includes some comments from a virtual tour guide, as well as a list of keywords to help the member understand resources available at this waypoint within the co-working space, which for the pantry include coffee, fruit water, meeting people, beer, happy hour, events, social, etc., while for the phone booth include calls, videoconference, privacy, quiet area, breakout, remote meeting, etc.

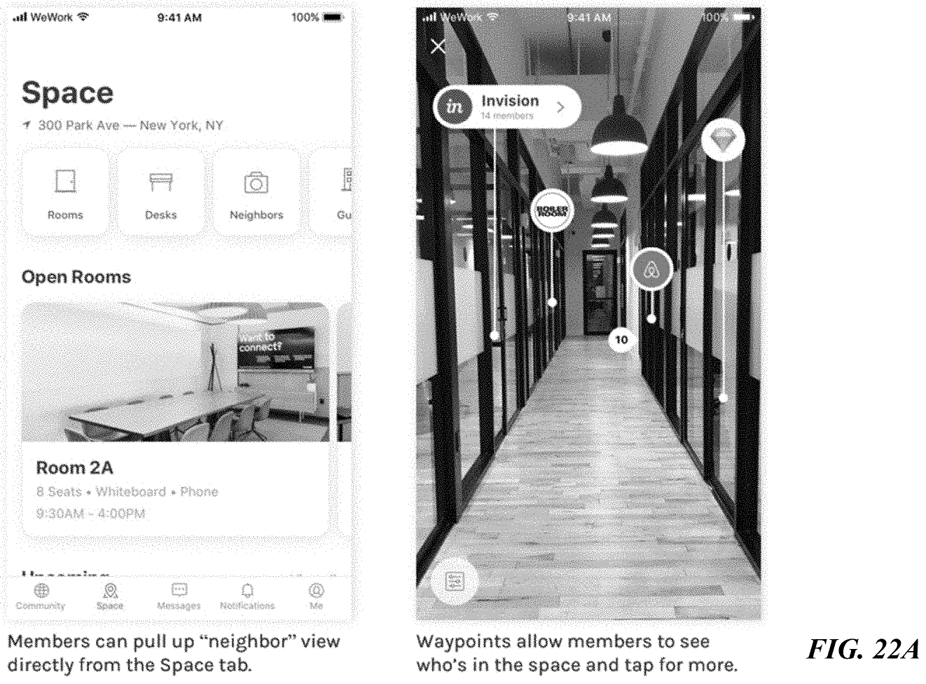

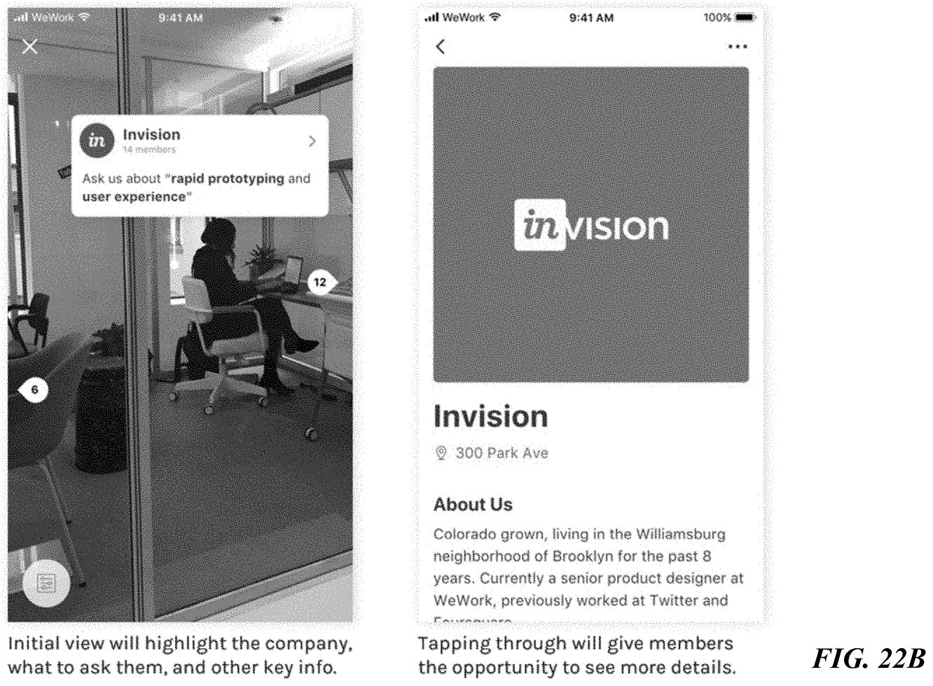

FIGS. 22A and 22B show an example of an augmented reality-driven GUI provided by the member app that allows members to walk the halls within a co-working space and obtain a quick view and understanding into what each company in the space does, who works there, and potential conversation icebreakers. This AR-driven GUI also assists community managers, and community teams can also use the member application to easily obtain information on companies within certain offices, thereby obtaining details on the company, any open support issues that are to be resolved, specific requests from that company, and so forth.

FIG. 22A shows a GUI for the member app that allows members to access a “Neighbors” option, which then launches an AR-driven interface to activate the rearward facing camera of the member's mobile device to display, in the depicted example, a hallway with offices to the left and right. Notably, the displayed hallway also includes icons overlaid on the display which indicate businesses operating within the displayed offices, such as “Invision”. FIG. 22B then shows a view of the office for Invision, and includes an icebreaker question that the member can ask of a fellow co-working member within that office. Further, the member app can display a screen showing more details regarding the business in that office. Overall, this AR-driven application within the member app allows members to explore their office neighborhood (e.g. floor or building) and understand various companies and fellow co-working members in their location.

### Space Occupancy Determination/Reporting and Occupancy Map Editing: Spatial Data Empowerment for Existing Users

Finding suitable spaces such as phone booths or conference rooms is difficult for members and leads to time-wasted and lower satisfaction, both because certain space types are commonly unavailable and because environmental conditions are unfavorable in available spaces. In addition to space scarcity, common complaints about spaces are related to thermal comfort (HVAC) and noise. Noise has even been correlated with reduced productivity.

The system described herein employs sensor networks to gather data on occupancy (e.g., via WiFi routers 113). As these networks are scaled to various locations, the system solves a need for visibility into space availability for non-reservable spaces, such as open seating, phone-booths, and nooks. In other words, the system can automatically gather data regarding whether a particular resource is being used or occupied by accessing sensors at or near those resources. If a conference room includes a Wi-Fi router, that router can detect whether members are occupying that conference room, by gathering Wi-Fi signals from mobile phones in that room, and can filter out Wi-Fi signals from mobile phones outside of that room by comparing received signal strength of signals from phones within the room, versus phones outside of the room. In this instance, no personally identifiable information would be received, only the presence of a mobile phone within the room.

Likewise, with respect to occupancy of phone booths, phone booths can include an IR camera with an obscuring lens so that the camera can detect the presence of a person within the phone booth, but not obtain an in-focus image of the occupant. Alternatively, a microphone, motion sensor, pressure sensor (in the floor or chair) can be used to detect for speech, motion or pressure of a member within the phone booth. In these instances, no personally identifiable information would be received, only the presence of a member within the room (e.g. the microphone does not record any audio, but is simply used to detect the presence of noise, which is sent a binary occupied/vacant signal.) In all instances, these sensors send data to the server 122, which in turn analyzes the data and provides updates to applications that collect occupancy and use data, and present that collected and analyzed data to community managers via a GUI (discussed herein). Furthermore, this data can be provided to the member app so that availability of non-reservable resources like a phone booth is provided to the member app to allow members to quickly find an available phone booth.

The system also collects data from environmental sensors and displays these conditions to members. When people have access to a window or control over temperature, they tolerate more extreme conditions and are generally more comfortable or satisfied with their environment. Data from environmental sensors can be obtained from smart/networked thermostats, smart/networked locks or other door entry systems, smart/networked window blinds controls, and so forth. Again, these sensors send data to the server 122, which in turn analyzes the data and provides updates to applications that collect occupancy and use data, and present that collected and analyzed data to community managers via a GUI (discussed herein).

As described herein, community managers receive a single interface or GUI that exposes everything occurring within that community manager's space, including members that are present, visitors, bookings/reservations of conference rooms and other resources, any priority support needs (IT issues to be resolved, important catering requests, etc.), and current building diagnostics, such as temperatures of rooms, bandwidth load on WiFi resources, status of all printers, etc. This interface will allow community managers to search all data stored in the database 124 that is relevant to that manager's location, thereby providing rich search results and provides contextual actions that the manager can initiate directly from the screen. For example, the community manager and community team will have, via the interface, more visibility into active support needs/requests, can track the progress of requests (and associated owners), and alert the building (community managers, members) on known problems and their statuses, such as whether an elevator is malfunctioning, a printer is being replaced, and so forth.

The member app also has access to some data stored in the database 124. The member app maintains a log of member interaction with the member app and sends that log to the server 122. The server, in turn, analyzes the data to thereby provide to members quick actions that they may need before they request those actions because the member app or server has determined that a given member typically performs a particular action based on that member's past behaviors and common patterns. For example, if that member registers two guests who previously visited that member, the member app can then automatically reserve an appropriately sized conference room for a meeting and simply ask the member to confirm the reservation. Likewise, the member app can automatically prepare a catering order for food or drink for the meeting and present that to the member for approval before making the catering request.

The member app can include a support center GUI that allows members to either find solutions to issues they face, or file requests for support needs. The requests may then be automatically sent to the server 122, which in turn issues a help ticket to the appropriate community manager or community team to resolve that issue.

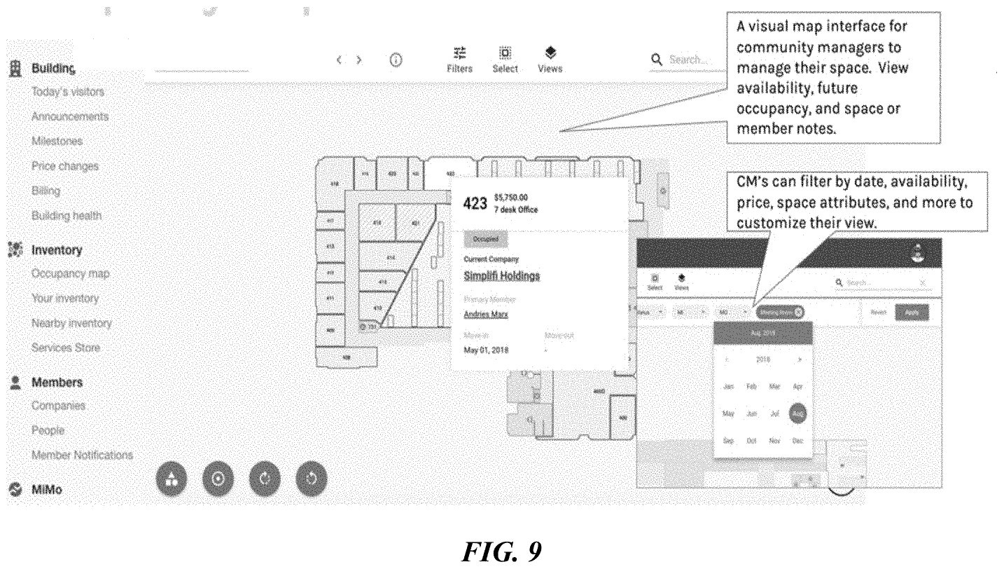

FIG. 9 shows an example of an interface for a community manager that displays a visual map interface to help the manager manage the space. The community manager can view the availability of offices desks and so forth, as well as identify future occupancy availability based on known members who will be leaving. The interface allows the community manager to also see details regarding companies, offices and members within the location and any notes or annotations associated with such data, such as the name of the company leasing certain offices, move-in date, move-out date (if available), primary or responsible member for that company, etc.

The GUI of FIG. 9 allows CMs to apply filters and thereby display only desired information. For example, the community manager can apply filters based on date, availability of resources (such as conference rooms), price (such as price of an office or desk for lease), attributes of a particular space, etc.

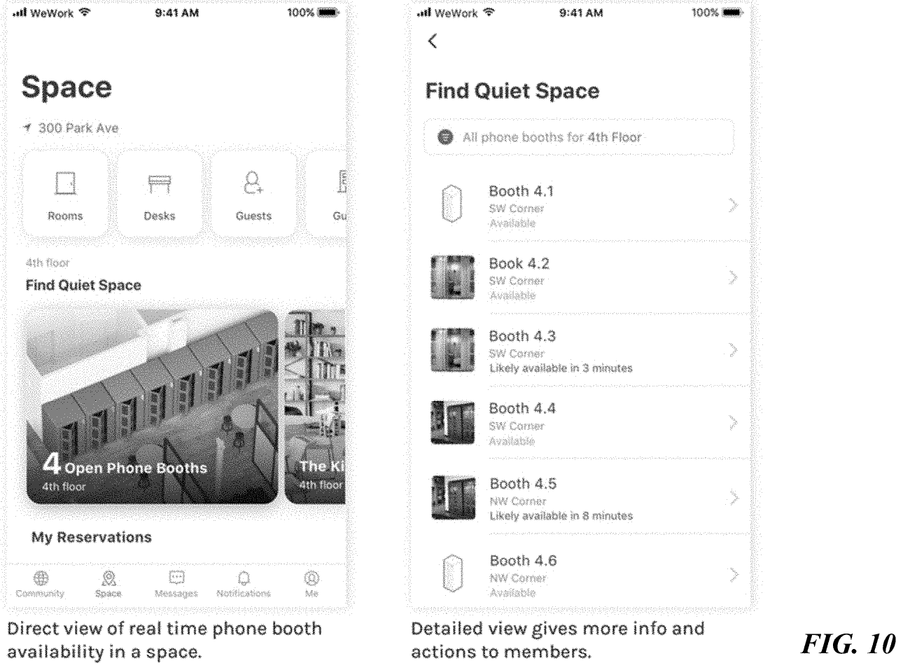

Referring to FIG. 10, an example of member app screens are shown where members can see available phone booths in real time. As shown, by employing the sensors noted above, the system can estimate, based on prior patterns, likely availability of resources like phone booths. While shown with respect to finding phone booths, the member app can help a user find other ad hoc spaces, such as small, on-demand rooms that accommodate 1 to 3 people. Such ad hoc spaces would typically be offered to users that need reservations, but only for a limited duration, such as 30 minutes. The member app can recognize (using spatial location data) when the user enters such an ad hoc space, and starts a timer to indicate to the user when 30 minutes are up and therefore the user should vacate the ad hoc space for use by others. Alternatively or additionally, the space may provide features to implement such timing, such as a countdown clock or red light, located outside of each ad hoc space, which can be activated when the user closes a door to the ad hoc space. The clock or light can then blink, illuminate or gain in illumination when 30 minutes are about to expire.

The system described herein can offer members the ability to find a space that matches their preferences via the member app. These “Spatial Insights” for members will contribute to overall satisfaction, as well as reduce the time spent searching for acceptable and available space. For example, the member app can employ geofencing to allow for dynamic location update, so that as a member moves within a floor, between floors, or between buildings, the member app updates based on current location to provide resources within a reasonable, current distance of the member.

As noted above, the member app can provide real-time, sensor-based phone booth availability, as well as any open-space availability. The member app can provide current or typical environmental conditions of particular locations within the space, such as whether a particular space is dark/light, quiet/loud, cool/hot, or empty/crowded, which can help the member decide whether to use a particular space such as a desk, phone booth or conference room. Further, the member app can allow the user to automatically, via the app, adjust certain parameters for certain spaces such as light levels, temperature, noise levels, etc. Moreover, the member app can provide spatial insights and location-based recommendations, e.g. indicate whether a particular lounge displayed on the map is likely to be busy tomorrow at 3 pm, or provide a notice to the member like “We noticed that you're in 300 Park Ave. The 5th-floor lounge is typically quiet.” if the member typically prefers quiet locations. Furthermore, the member app can allow members to share location and status with other members, either within the same company for whom they work or among all members within the co-working location.

The system described herein makes information available to members and community teams in an intuitive spatial format (maps, floorplans) because it can be difficult for teams to keep pace with processing spatial data made available as locations open. The system provides a single and intuitive map interface that displays relevant business data and intelligence. Notably, the system avoids the following:
Confusion from end-users when the physical site, in reality, does not reflect the map they see it (e.g., data errors and/or incomplete data such as lack of furniture);
Disempowerment as end-user cannot easily fix/flag concerns; and/or
Frustration that a displayed map does not synchronize seamlessly with other tools, such as Spacestation.

The member app not only displays maps within a map client but also provides editing functionality within the map client that enables a feedback loop to collect and cultivate real-world changes in a scalable, timely and cost-effective way. This provides a scalable platform for maintaining existing buildings as/when they change over time.

The map client can employ space models processed and supplied via core platform physical space APIs to help identify and capture discrepancies, thereby allowing end-users to make changes to this data, which will feedback and synchronize with the core platform. In many cases, these minor, ‘light’ changes will not need to result in changes to original, architectural plans/models as they are inconsequential to the physical design. These changes can result in fresh, accurate, high-quality building data, curated in a scalable way by resources on-the-ground and best placed to maintain and own this process. Better data will result in higher satisfaction amongst users, higher adoption of the tool and data that reflects physical reality as closely as possible.

In order to mitigate concerns on data quality and access, this editing functionality can be controlled at user permission levels, e.g.:
Level 1 user—view/read-only
Level 2 user—e.g., Community or Sales Analyst/Lead—edit ‘light’ attributes (e.g., meeting room name) and flag ‘heavy” attributes (e.g., re-classify meeting room to a private office).
   Can require proof (e.g., upload a photo of the space or requested change) and/or Community Manager approval
   can include automated validations (e.g. private office should not include hotdesks, minimum square footage per desk)
Level 3 user—e.g., Community or Sales Manager—edit ‘light’ attributes without approvals—can be one person per site/owner
Level 4 user—e.g., Mapping Services and/or Core Platform and/or trained production team—data owner that can modify ‘heavy’ attributes based on an assessment of proof/approvals
Level 5 user—Super Admin

The system can thus take an existing, inefficient process (one-way stream of data) and create a feedback loop that allows for an agile, scalable and ongoing maintenance cycle. More accurate data will help build confidence in the Map Tool for end-users, as well as add to a larger, fresher library of building data that most closely reflects physical reality at any single point in time.

### Community Building and Interface

The member app and community manager interface allow information, activities, resources and services or offerings to be provided to members. The community manager can quickly create announcements for all numbers within a given location by accessing categorized announcement templates from which announcements can be created. The community manager interface can save all past messages for easy resending or editing. The member app then presents these announcements or updates to announcements to members and can immediately push emergency notices to members.

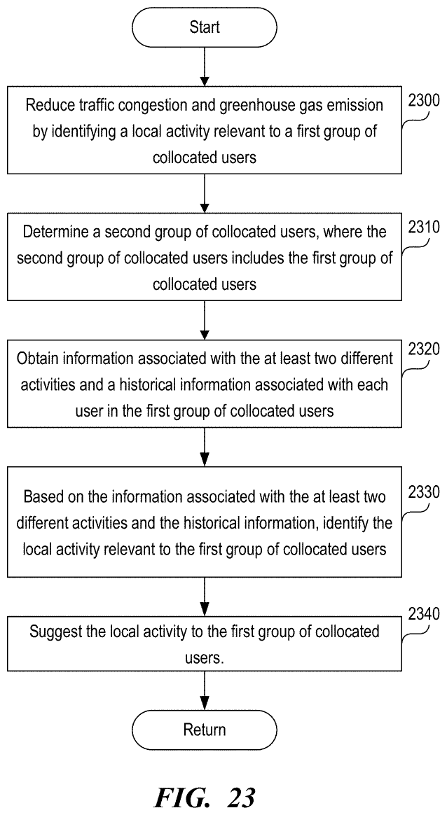

Via the member app, members can access a structured way for members to express needs or requests they may have, where needs are presented to members in a structured way that they can select, which assists in matching needs for services with services offered by other members. The server 122 can process these member-posted requests for help or requests for fulfilling a particular need, and respond to requesting members with recommendations for other members who may be able to satisfy that need. However, the community manager or community team in a given location can also access these member-posted requests to attempt to find matches that they may know of. The server 122 and/or the member app can perform the steps described in FIG. 23 below.

The member app allows members to promote themselves and their businesses to a targeted audience and in a way that is less spammy or otherwise intrusive on the community network. For example, a member can, via the member app, provide a promotion of that member's business and its services or products, which is stored in the database 124. Then, when another member organization requests products or services that match that promotion, the server can automatically provide the previously stored promotion from that member. Likewise, community teams can gather information or notes regarding members within their location, which are stored in the database 124. Then, when a member requests or expresses a need for a product or service, the server 122 can access the database 124 to find a possible match for the request.

For example, if a member were to post a request in a member feed provided to the member community, the server 122 can analyze the request to see whether another member's product or service in that other member's promotion, matches the request, and if so the server presents the promotion to the requesting member. The community manager interface will likewise present to the community team promotions posted to the member feed by members so that the community team is aware of the products and services offered by members within the location managed by that community team. The community team can thereby identify and match members offering products and services to members requesting those products and services.

By providing a structured way of articulating both requests for products/services and promotions of products/services, the system described herein can allow members to automatically search for particular products/services within the network, or to browse by common needs, by using the structured format. Such a structured format can articulate particular products and services, such as accounting services, legal services, bookkeeping services, catering services, design services, etc. Such a structured format allows for new posts to the member feed to employ similar terminology and format, thereby making it easy for members to promote products/services in an aesthetic way using an interface understandable by other members (e.g. via the member app interface). Using the structured terminology, the server 122 can then more readily match requests for products/services that use the structured terminology to promoted products/services that likewise use the structured terminology.

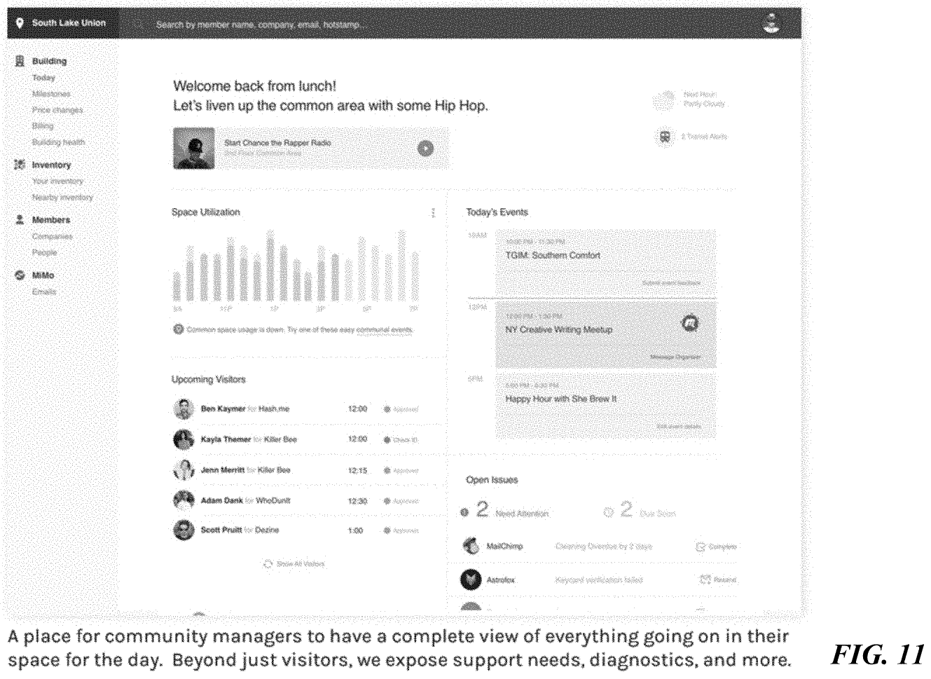

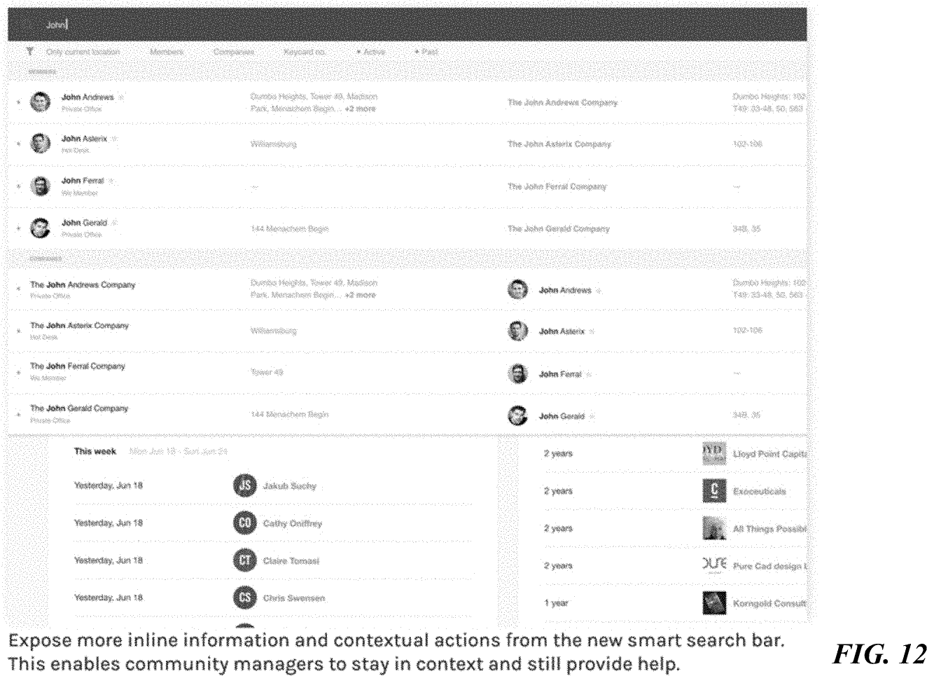

FIG. 11 shows an example of a GUI displaying a complete view of everything going on in the space for a given day. The GUI of FIG. 11 is provided to the community manager. It provides information regarding visitors, support needs, diagnostics, community events for that day, recommendations for music to play at a given time, and so forth. FIG. 12 shows the community manager interface with in-line information and contextual actions from a search or query, thereby allowing managers to stay in context and still provide help. For example, by searching for “John”, the interface displays various query results, such as members with the first name “John”, companies that contain the word “John”, and basic information regarding the query results.

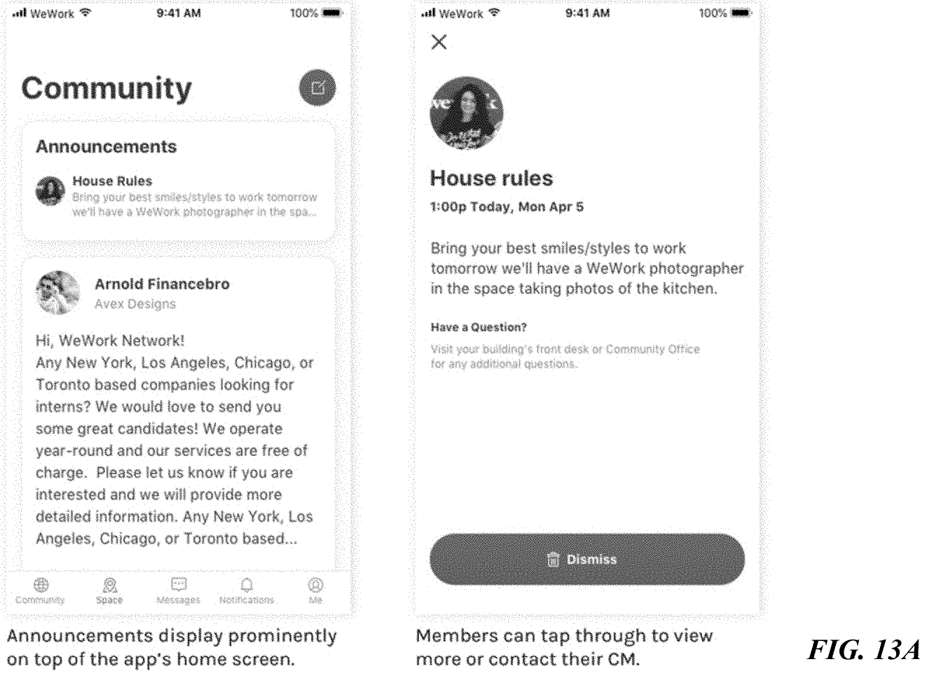

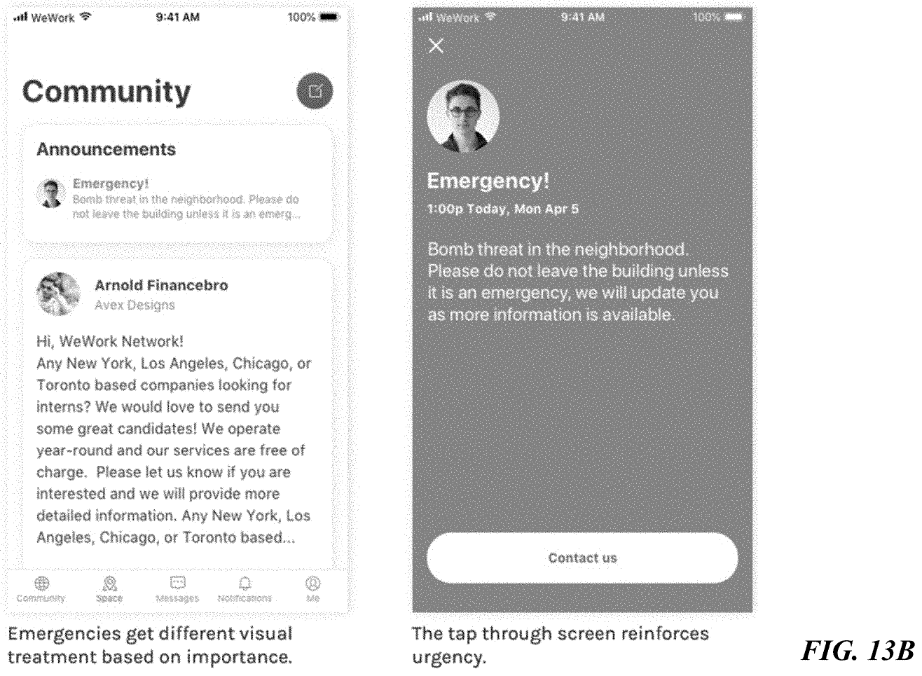

FIG. 13A shows an example of member app GUI screens, which includes a vertically scrolling list of announcements, such as a House Rules announcement (displayed prominently at the top of the member app home screen), and a promotion posted by a member seeking to place interns. FIG. 13A also shows that by clicking on the House Rules option, the member app GUI displays details on the house rules announcement, after which the member can post a question to the community manager, or dismiss details on that announcement.

FIG. 13B shows an example of an emergency announcement. Emergency announcements are immediately placed at the top of the member app GUI, and highlighted to provide visual importance and notice to members. By selecting the emergency announcement, details regarding the announcement are provided (such as details on a possible bomb threat).

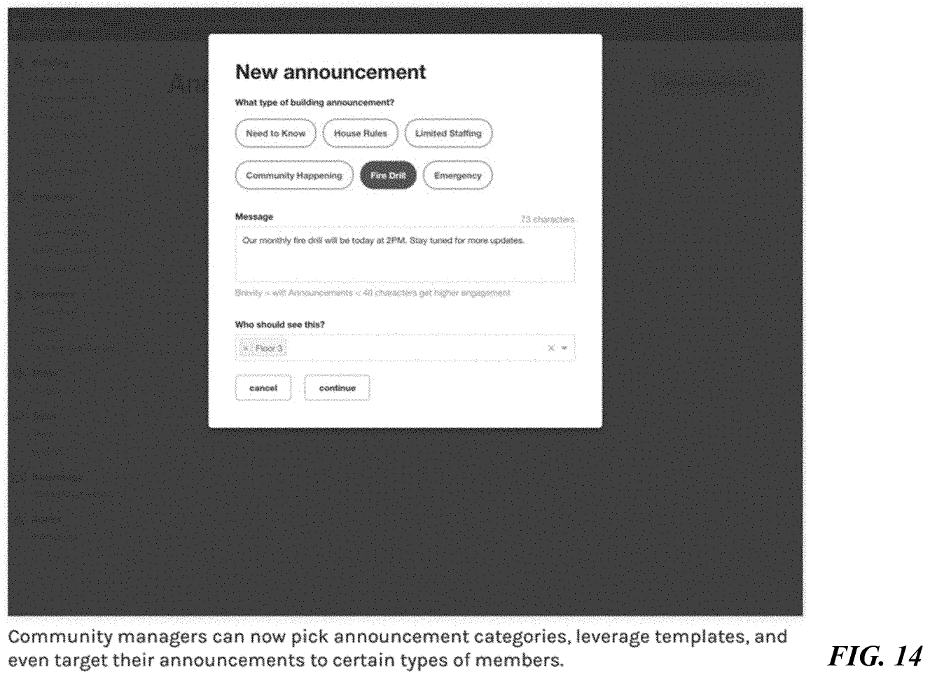

FIG. 14 shows an example of a GUI to permit a community manager to post a new announcement. As shown, the GUI displays structured terminology or keywords from which the community manager can select (such as Need to Know, House Rules, Limited Staffing, Community Happening, Fire Drill, and Emergency). After selecting one of the keywords, the community manager can input a message into a text box, and then select who will receive the announcement (such as selecting members of a particular floor, members of a particular group, etc.). In this way, community managers can pick announcement categories (such as Fire Drill, House Rules), receive an associated template to create the announcement, and then target the announcement to certain types of members.

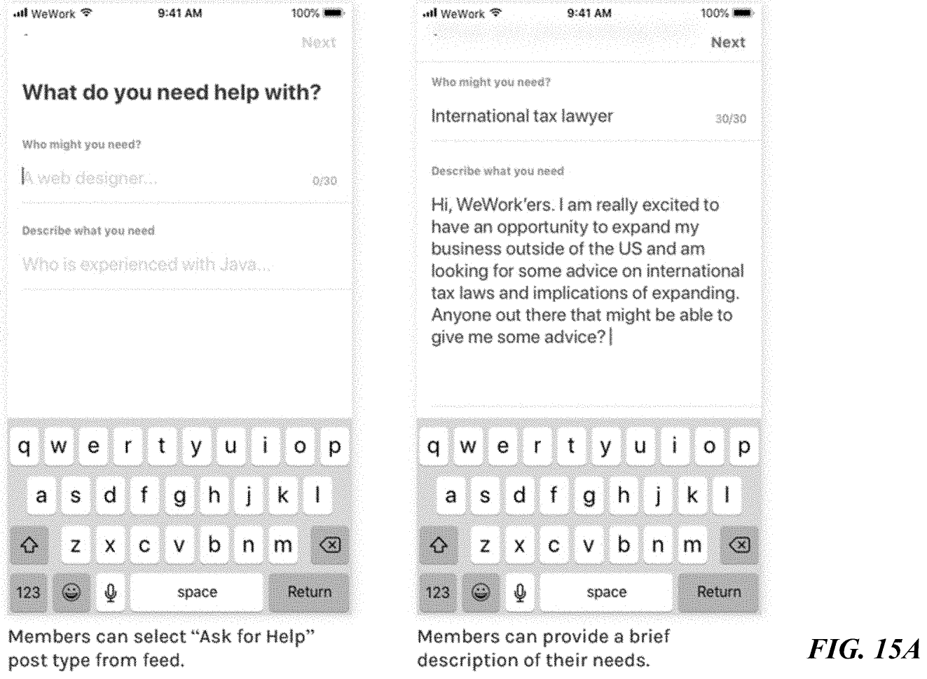

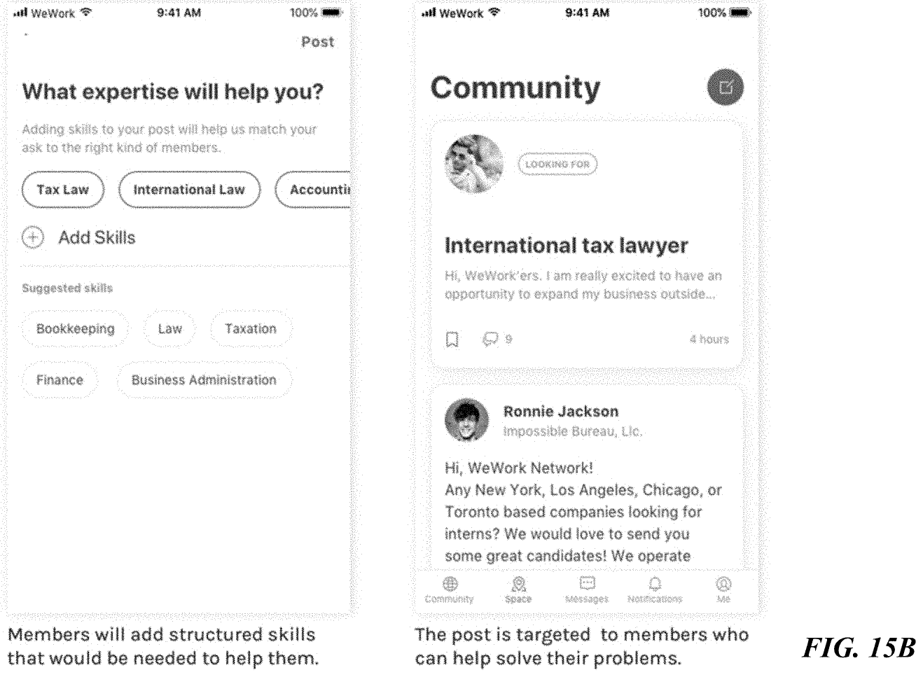

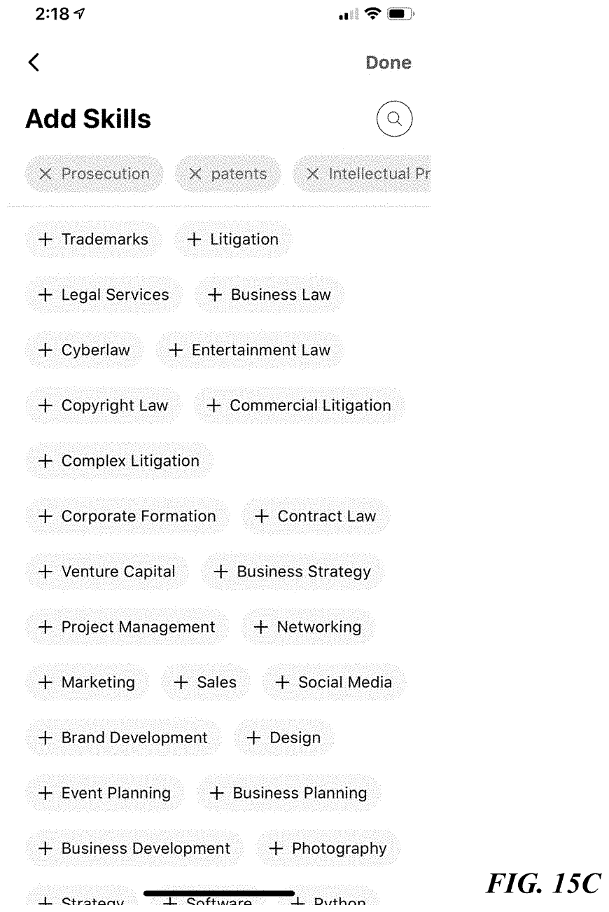

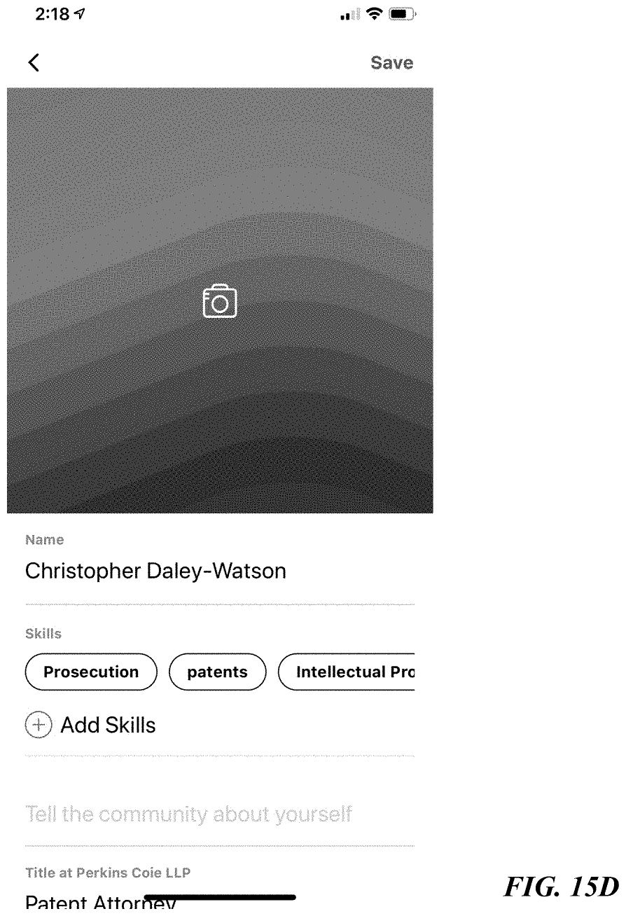

FIG. 15A shows GUI screens of the member app that allow members to ask for help and post a request for products, services or make other requests to fellow members. FIG. 15B shows how members can, via the member app GUI, add structured skills to help post the request. In the example shown, the member is requesting help from an international tax lawyer, so the member app presents to the member a restricted vocabulary or set of keywords such as Tax Law, International Law, and Accounting, as well as Bookkeeping, Law, Taxation, Finance and Business Administration. The member app employs natural language processing of text entered by the member to match member input text with the set of keywords to identify matches and provide a limited number of matching keywords via the GUI. Thereafter, the user posts the request to the member community, where the request is posted in the member feed and displayed to all members via each member's member app, or is displayed only to those other members who supply goods or services requested by the first member.

FIGS. 15C-15D show how a member can update their profile to advertise services and products than the member can offer. In FIG. 15C, the member app can offer a list of skills from which the member can select, or the member can input a skill that is not in the list. To generate the list of skills, the member app can obtain profiles of all the members, and analyze the profiles to extract relevant skills. For example, to extract relevant skills, the member app can identify company names, and based on company names retrieve skills associated with the companies. In another example, the member app can obtain resumes of the members, and extract items listed in “Skills” section. A skill can be defined as a phrase delineated by one or more commas. In a third example, the member app can identify keywords in the profiles, such as “expertise”, “experience”, “work”, etc.

FIG. 15D shows the member and the selected services and products that the member can offer. If the member has uploaded a picture, the picture can be shown so that other users can easily identify the member offering the needed services.

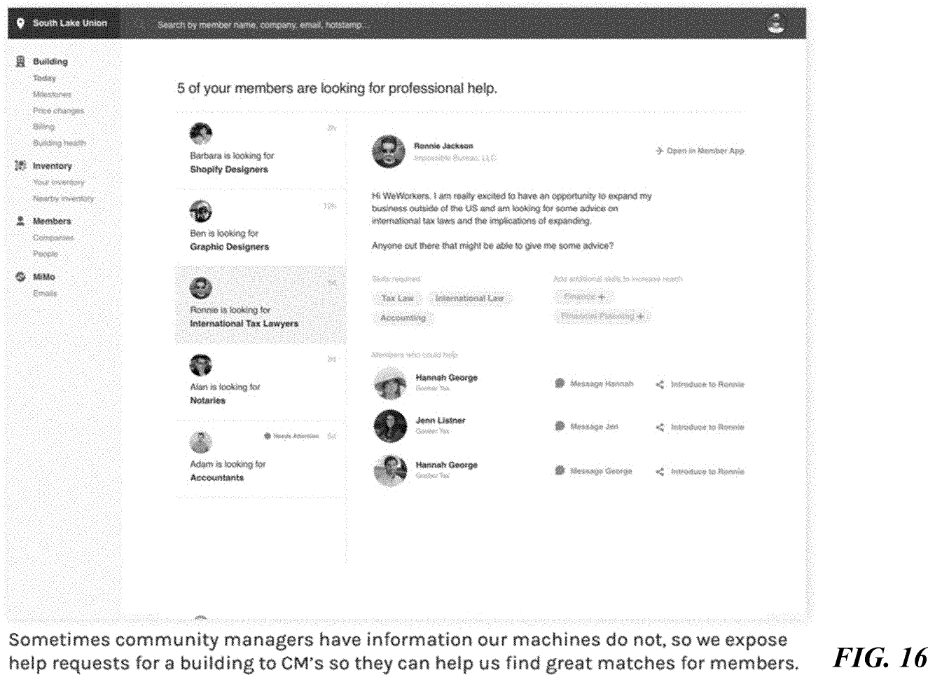

FIG. 16 shows an example of the community manager interface that displays to CMs a list of members who have posted requests for products or services and displays other members who might be able to satisfy those requests. In the displayed example, one member “Ronnie” is looking for international tax lawyers, and the interface displays several members who provide tax services and who may be able to assist. The interface allows the CM to quickly send a message, such as a text/SMS/MMS/email message to any of the three tax service providers, or introduce any one of the three to Ronnie.

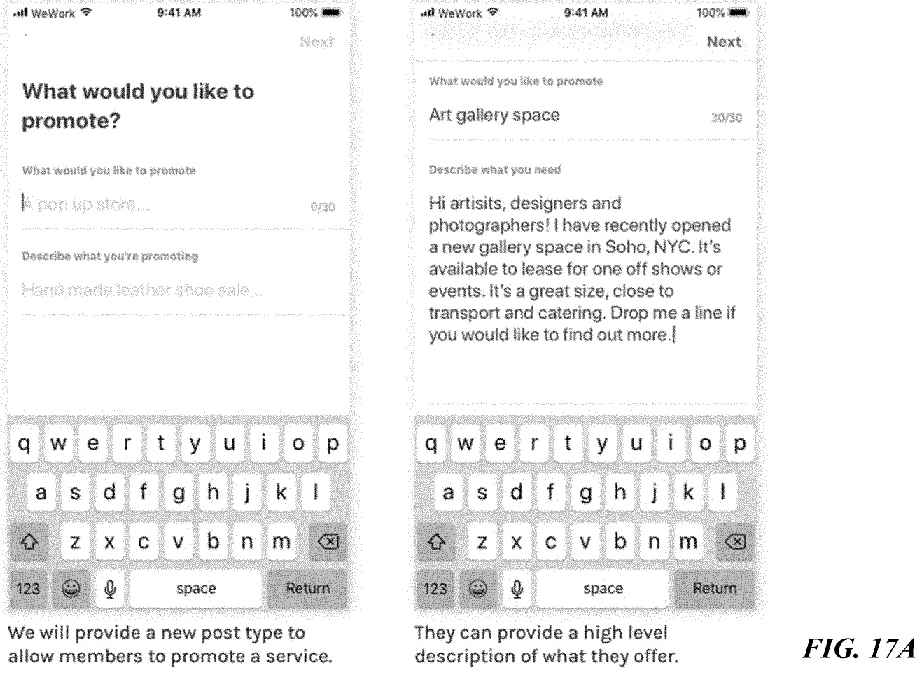

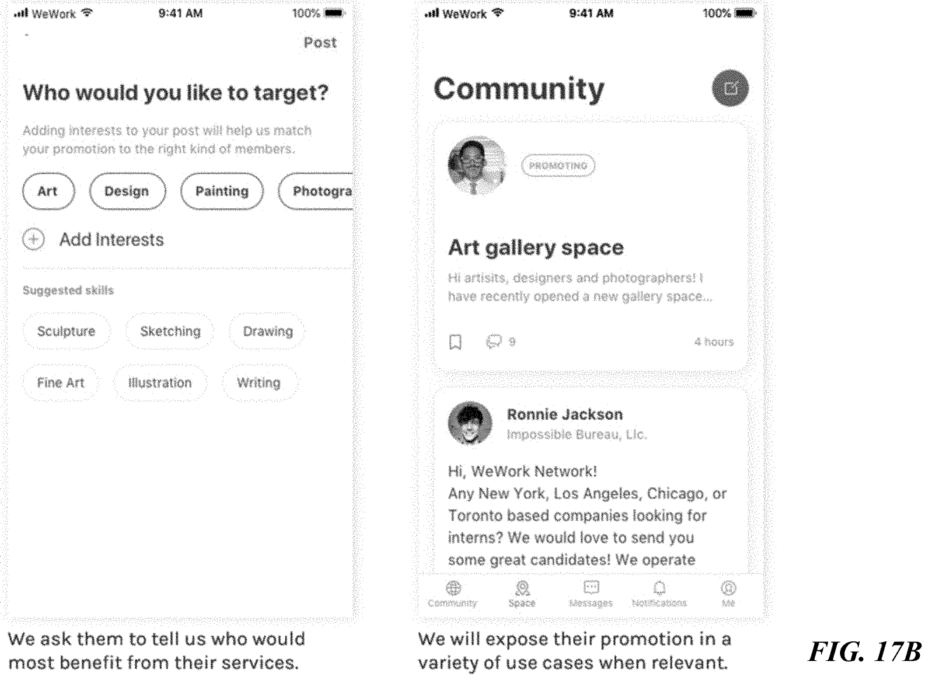

FIG. 17A shows GUI screens of the member app that allow members to create new posts or messages to other members allowing promotion of a particular member's product or service. The GUI specifically allows members to provide a short description of what they would like to promote, followed by a detailed description of what they are promoting. In the example shown, one member is promoting a new art gallery space, and is seeking designers artists or photographers wishing to lease space at the art gallery.

FIG. 17B allows the member then to select interests to help match the promotion to the right kind of member. The GUI uses linguistic analysis of text entered by the member (in FIG. 17A), and displays a set of keywords or structured vocabulary based on that linguistic analysis. In this example, the GUI presents a list of interests that include Art, Design, Painting, Photography, Sculpture, Sketching, Drawing, Fine Art, Illustration, and Writing. The server 122 receives the input promotion request to post to the member feed, whereby the server can present the post to all members, or only to members who have expressed some indication that matches one or more of the keywords.

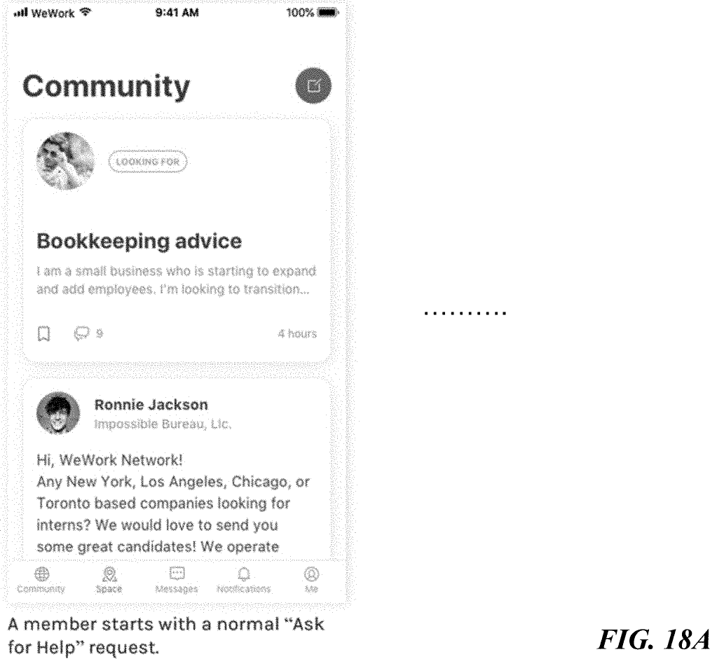

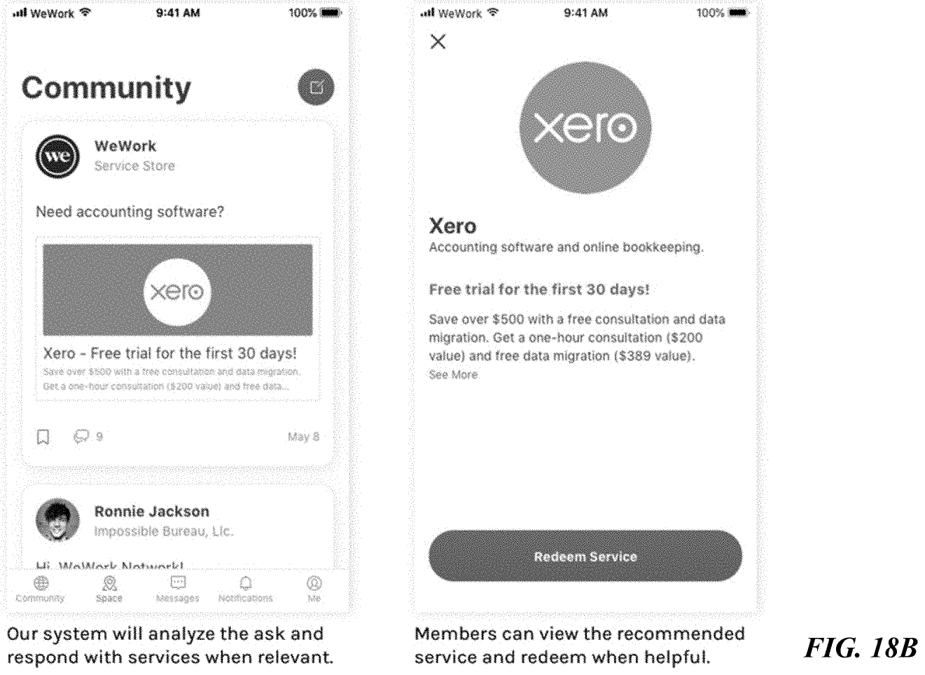

FIG. 18A shows an example of the member app GUI where a member can input an ask for help request. In response, and as shown in FIG. 18B, the server 122 parses the input request for help and provides back to that member any products or services offered by other members. In this example, a member is requesting bookkeeping advice, and in response, the server 122 provides to that member information on accounting software by Xero. The member can then click on the provided information to thereby receive further information, including the ability to access special promotions offered only to fellow members within the network.

Community managers can post events for members within that community manager's location, where such posted events are displayed by the member app for each member within that location. The server 122 can access the member data 128 to understand the population of members within the location and thereby identify specific events that map to interests of those members. The community manager can then create and post to those members events, coordinated by the community team, for members within the location. Those events would be matched to the skills, interests and past interactions of members in the member app. All events can be posted directly to the main member feed within the app.

To assist community managers in creating and publishing events, the community member interface (“Spacestation”) provides possible ideas for events (for example drawn from analysis of the member data 128, assists in automatically booking space (such as reserving space within the location), and provides visual assets (such as pictures of yoga teachers to add to a post for a yoga event), and displays a calendar of all events for the community manager. As a result, events have a uniform and aesthetically pleasing appearance within the member app. Members can select on a given event to gather more information on that event, can bookmark that event to receive more notifications on it, and can chat with others who may be attending that event. In this way, the system allows for easy event creation flows, and the creation of new event pages.

Once community teams have created an event, Spacestation permits the community manager to easily share the newly created event with members within the location. The events can also appear on TVs or display screens within common areas of the location, as well as in the member app. Further, Spacestation can automatically print posters or other notices to be posted within the location for members to see. In this way, the system provides automatic event marketing.

Once an event has ended, members can share feedback on that event. This feedback is fed into the database 124 and analyzed by the server 122 to provide future recommendations to the community manager to help craft better future events. In this way, the system provides an event feedback loop to improve future events.

The system described herein provides a collaboration and learning space for a global member community. Community managers can see all past events by topic, discuss best practices with other community managers at other locations, and share “recipes for delighting members” or other recommendations. Members, in turn, are exposed to more relevant events not only in locations in which members work, but also events in nearby spaces or buildings, or via MeetUp events. Further, events can be of higher quality because they are inspired by past successes of other community teams.

Members can create events of their own and invite like-minded fellow members, thereby creating more informal gatherings around topics of their choosing. Data from past MeetUp events can be gathered to suggest gatherings or events of a similar type at the same or different locations. (Information regarding MeetUp events can be found in U.S. Pat. Nos. 9,654,425, 9,135,663, 8,359,206, and U.S. application Ser. No. 15/157,685, all of which are incorporated herein by reference.) When members gather informally like coordinating a meeting via the member app, the member app provides such information to community teams to allow community teams to help facilitate the gathering. This helps the community teams understand connections made among members within the location to allow thereby the community team to provide better service to members within the location.

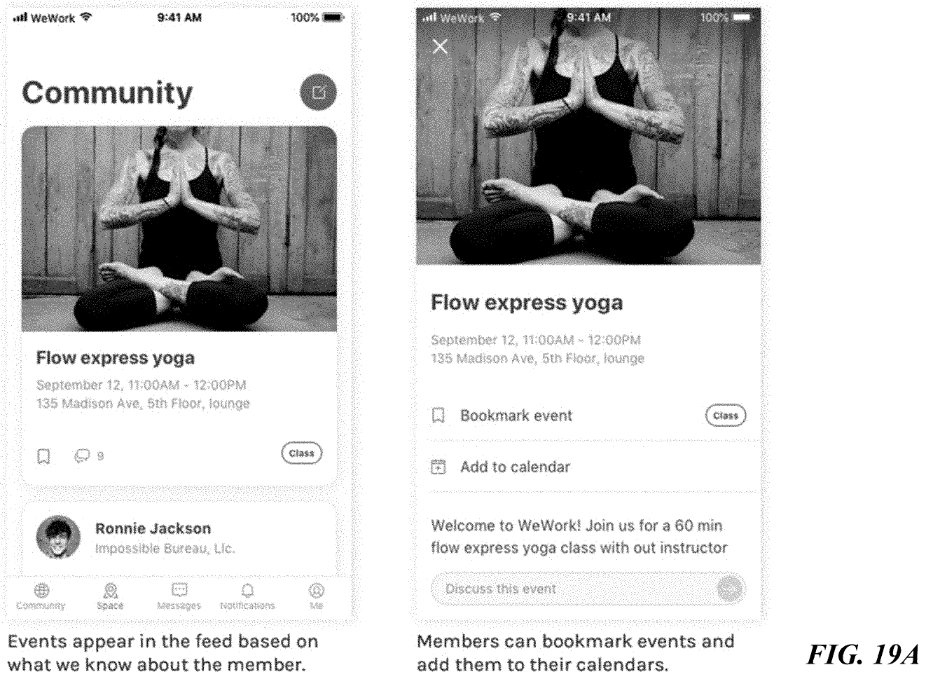

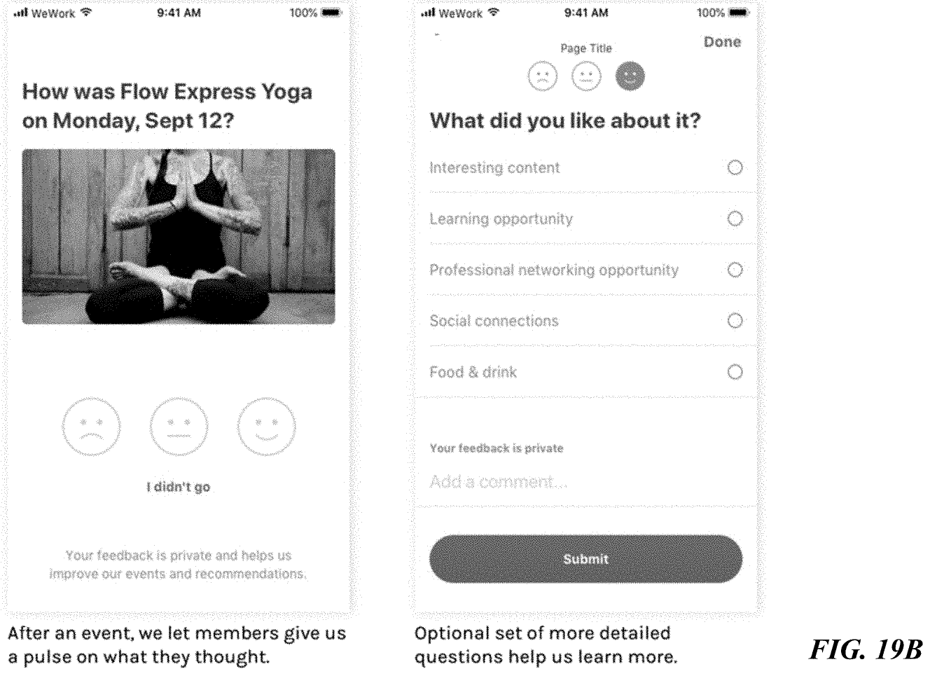

FIG. 19A shows an example of the member app GUI displaying an event (Flow express yoga), which appears in an event feed provided to members at a given location based on express interest provided by the member (by selecting interests when registering as a new member or providing information in a personal profile), or inferred interest whereby the server 122 analyzes data from the member and suggests events based on interest or past behavior of that member. Members can bookmark an event to thereby obtain further information regarding that event as it is posted, and add that event to their calendars.

FIG. 19B shows an example of a feedback screen whereby a member can provide feedback after an event, whereby feedback can provide simple feedback such as positive, neutral or negative feedback, or more detailed feedback. In the example shown, a member provided positive feedback, and then the member app presents a GUI screen that allows the member to provide further details or answer certain questions regarding why she liked the event. Such feedback helps the system craft better, future events.

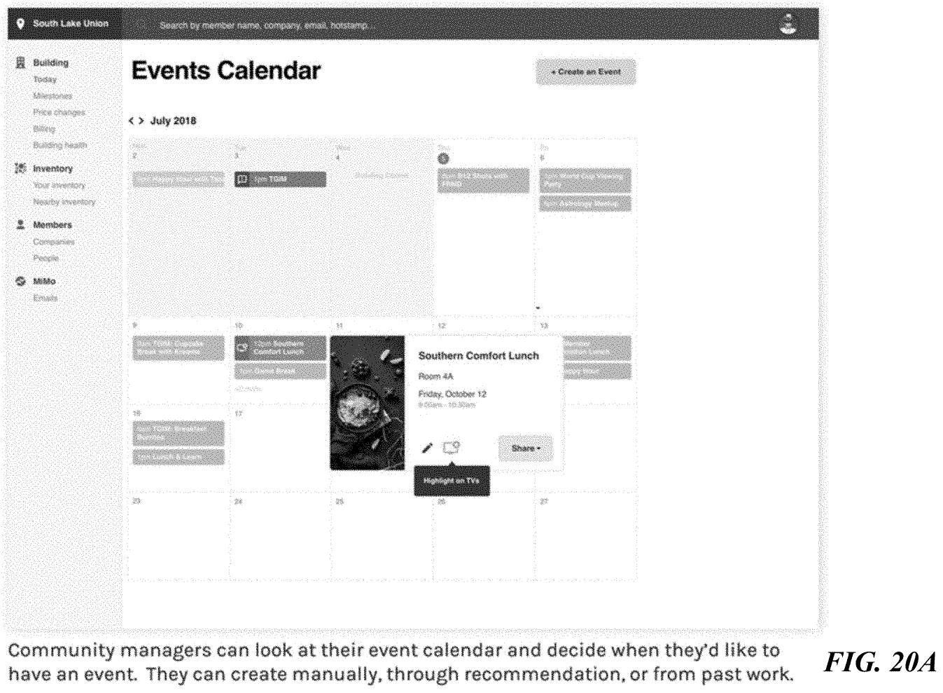

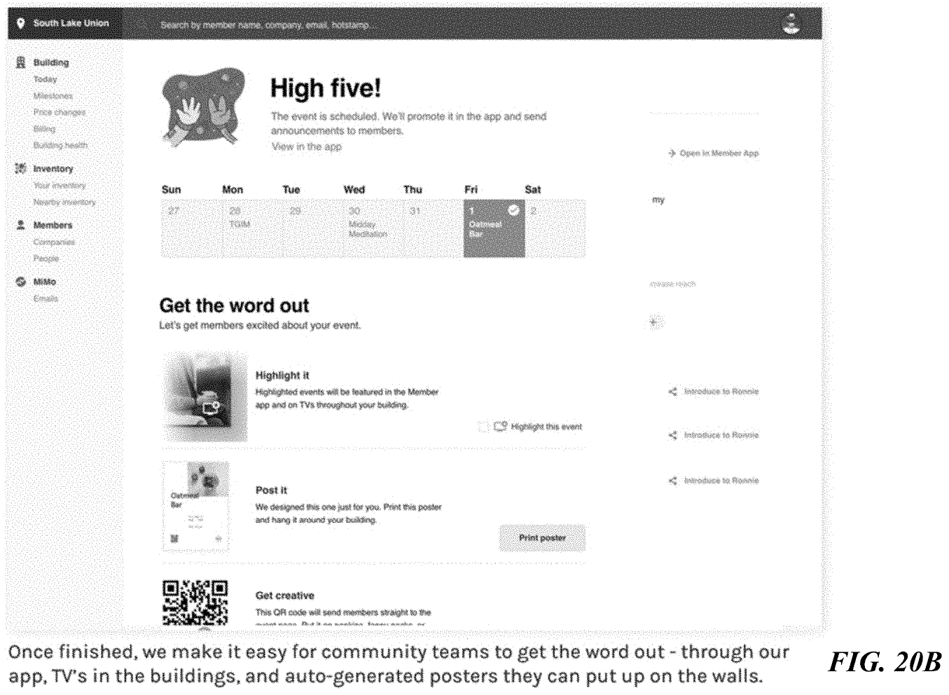

FIG. 20A shows the community manager interface with a calendar displaying events during a typical month. Community managers, via the interface, can create new events. Community managers can create events manually, through recommendations provided by the server 122, or by retrieving prior saved events to republish. FIG. 20B shows an example of a new event “Oatmeal Bar” created by a community manager. The interface allows the community manager to highlight the event by having it displayed on not only the member app, but also on TVs or other displays throughout the floor or building. The interface allows the community manager to automatically print posters that the community team can post throughout the building. Further, the community manager can add a QR code to posters that allow members to simply scan the code on their mobile phones and have the event automatically added to members' calendars in the member app, and automatically register members for the event.

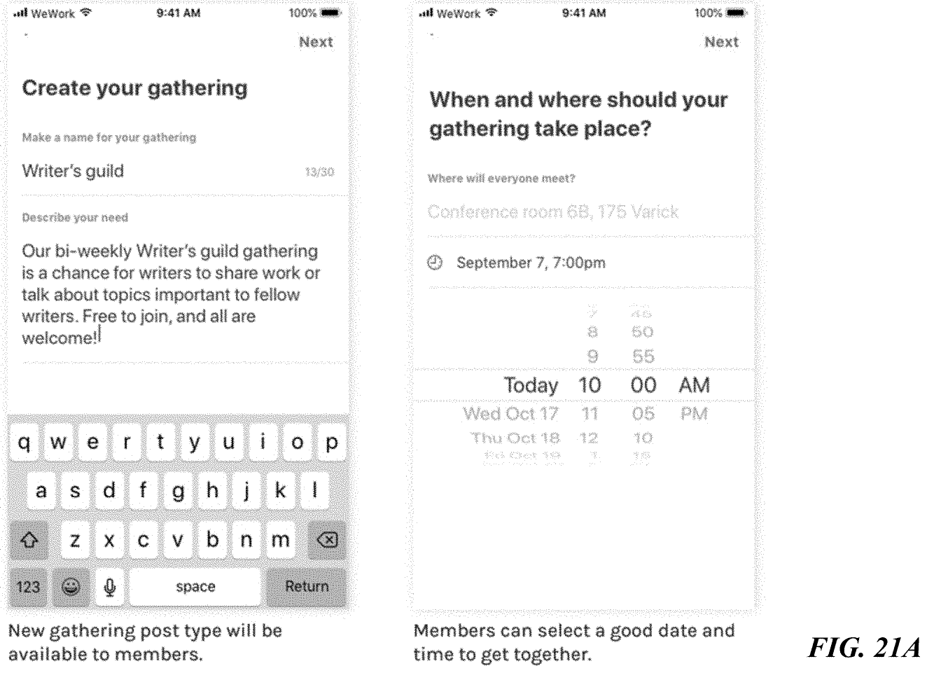

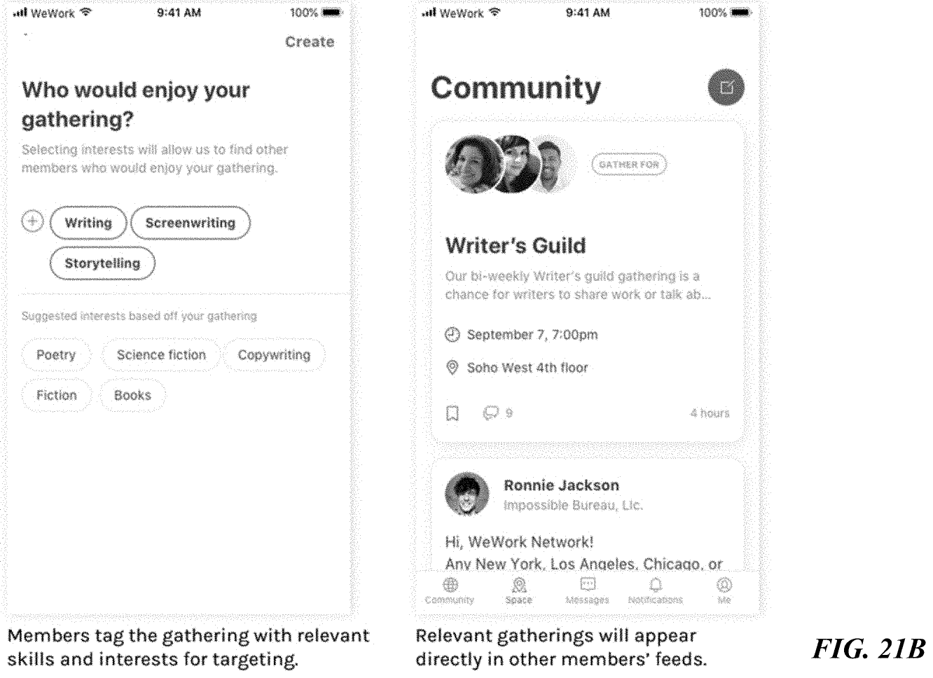

FIG. 21A shows an example of a GUI for the member app that allows members to create their own gathering. In this instance, the GUI allows members to provide a short name for the gathering in a first field (for example, a field limited to 30 characters), followed by a free text field that permits members to describe the gathering. A separate GUI screen allows members to select a date and time for the gathering.

FIG. 21B shows a GUI screen where members can select interests based on keywords or other limited, structured language. In the depicted example, a member posts a gathering for a “Writer's Guild”, and the system displays suggested keywords such as Writing, Screenwriting, Storytelling, Poetry, Science fiction, Copywriting, Fiction, and Books. Once complete, the gathering is posted with other gatherings directly in the member feed for members previously indicating as having an interest in those gatherings, such as based on selected keywords.

### Parking

Inconsistency in facilities' approach to parking results in poor member experience, lost revenue, and operational inefficiencies in car-commuter markets. In certain locations, member parking is a necessity (e.g. Los Angeles), while in others it is not (e.g. New York). In addition, some locations manage their own parking, while others rely on a landlord or third party parking management. In locations where an organization manages parking, managing available spaces and billing for parking can be disconnected and manual.

The system described herein provides a platform for parking management that allows for the capture of lost revenue and to more effectively and efficiently manage parking. The system can work with valet companies and aggregate underutilized parking from private sources to provide a scalable parking solution.

The system allows for accurate and efficient management of parking, and can give members more control over their accounts and parking. The system may provide a “rideshare-like” model for parking, thereby unlocking underutilized spaces and giving access to members at a reduced cost relative to dedicated monthly parking. For example, members can go to the member app and select parking spaces near their location and reserve those spaces in advance. Pricing can scale from pay by the hour to unlimited for a fixed monthly fee.

The member app can integrate with various other systems such as DIVRT (or other) parking management integration app, a parking management module provided via a community-facing application such as Spacestation, and/or via a parking management module for member facing applications via the member app (in a manner similar to that for reserving conference rooms).

For example, the member app can access a database of available, reserved and unavailable parking spaces located near the current location in which the member works. In this way, the member app provides a GUI to display available parking spaces and their location relative to the office or location which the member works. Displayed parking spaces can include associated costs or points to reserve or rent them, where such prices can vary based on time of day, day of week, discounted group rates, and so forth. The member can then select and reserve a desired parking space via the member app in a manner similar to that for reserving a conference room, including specifying the time during which the parking space is reserved.

### Printing

Members often have issues with printing, and members struggle with driver installation, printer malfunctions, lost prints in queues, and the ability to control/optimize when/how they print. The system described herein provides a seamless printing service allowing members to print effortlessly, virtually anywhere, to any printer—securely through the cloud. Specifically, the system employs a uniform printing network and driver system whereby members can easily set up for printing by employing a specific printing profile that may be universally applied to all co-working locations, without the need for downloading and installing different printing drivers. Further, members can connect to available printers, print from any network, print via any printer on the network, and easily be charged for such printing.

Community managers can receive tools to better assist members with any refunds and understand issues associated with printers to thereby provide proactive support. Members can receive tools via the member app to better understand the status of printing jobs, and understand billing charges.

### Food/Beverage Partnerships

Getting food and beverage for groups of people, as well as for busy individuals, is a task that is fraught with searching, decision making, and points of friction that add unnecessary time and effort to members' days. Coordinating lunch for meetings is often an additional step that adds several additional layers of friction to planning: finding acceptable restaurant or caterer, ordering, receiving food (both at building and in a meeting room), setting up food station, and clean up.

In addition, as individuals, members keep busy days that don't always allow them time to step out to pick up lunch, and lunch delivery in a building often means having to go downstairs to pick up. Members spend time each day thinking about what they should eat for lunch, when they should go, and wondering if they have time to grab something. Quite often they end up on the same solution of running to the lunch location nearest to them for a quick pick up before their next meeting or call. Additionally, grabbing food that is closest to a member's location doesn't always result in healthy and happy decisions.

The system described herein allows members to save time and reduce decisions made each day by making it easy for members to have food and beverage services easily selected and delivered to them each day. The member app offers food and beverage services during members' workday, and helps them stay focused on what they need and want to achieve while in the office.

Food is additionally important because in many parts of the world, people connect around a table of food. For many, conversations start easily when sharing a meal. The member app therefore not only reduces decisions made by making it easy for members to select lunches offered at or near the members' location but to also helps members connect over meals organized by us in community spaces.

A majority of members purchasing food or beverage in their neighborhood at least twice a week, but with an automated system via the member app to automatically purchase food or beverages, a share of the revenue from these purchases can be obtained.

The member app allows for the selecting, ordering, purchasing, and delivery of food and beverages seamless. The member app allows a community team to develop catering partnerships for large groups/meetings, partnerships with curated food vendors, daily curated menus, group purchasing discounts, deliveries and runners to specific floors/desks at the location, and “Family lunches”/organized group meals within common spaces.

The member app can present multiple catering options, and present a selectable GUI that permits members to select a particular caterer, and then select either complete menus or individual food options, and then place an order. The food is then automatically delivered to the members' location, and the members are automatically billed for delivered food.

### Keycard Registration

Often the process for members to register their keycards to access a facility is difficult and unreliable. Some organizations have merged keycard registration with identity verification, but this can add friction and is a common point of failure. In addition, members are often asked to guide themselves through this process, during move-in, which adds an additional layer of friction, wasted time, and potential frustration.

The keycard system described herein unlocks a member's future in various co-working spaces, both literally and figuratively. The process of getting a key card should feel significant, and even magical, like getting one's first set of car keys. The process permits members to automatically obtain a key card without having to go through a second level of verification if appropriate information or credentials have previously been provided by those members' employers and stored within the database 124. Key cards can be electronic or virtual and stored on members' mobile devices whereby near field communications (NFC) provided by the mobile device permits access to buildings having similar NFC communications and associated locks. The system provides to community managers, such as via Spacestation, tools to preregister key cards in batches to new members, such as those joining from a particular company that has previously registered with the company leasing space in the location.

### Flowcharts

FIG. 23 is a flowchart of a method to reduce traffic congestion and greenhouse gas emissions. The server 122 and/or the member app can perform the steps described in FIG. 23. In step 2300, a hardware or a software processor executing instructions described in this application can reduce traffic congestion and greenhouse gas emissions by identifying a local activity relevant to a first group of collocated users.

In step 2310, the processor can determine a second group of collocated users, where the second group of collocated users includes the first group of collocated users. The second group of collocated users can be frequently collocated at predictable times. For example, the second group of users can work next to each other, such as in the same hallway, floor, building, or a neighborhood block. The second group of users can also attend the same school, same classes, same activities. For example, the second group of users can be frequently collocated at predictable times, such as 9 AM to 5 PM during weekdays, or 6 PM to 8 PM on weekends. The fact that the second group of users is frequently collocated predictable times, enables the processor to accurately determine a time window during which the second group of users are collocated.

At least two users in the second group of collocated users can be engaged in at least two different activities. For example, the at least two users can work in different jobs, or take different classes, so that they have different skills and can aid each other.

In step 2320, the processor can obtain information associated with the at least two different activities and a historical information associated with each user in the first group of collocated users. For example, the processor can obtain a description of an offer provided by a first user in the first group of collocated users, and the description of a request associated with a second user in the first group of collocated users. In a more specific example, the offer can be an offer to create a webpage, and the request can be a request to develop a software application. The processor can determine whether the offer matches the request, and upon determining that the offer matches the request, the processor can provide the offer to the second user.

In step 2330, based on the information associated with the at least two different activities and the historical information, the processor can identify the local activity relevant to the first group of collocated users. The two different activities can include the activity in which each user is engaged when the user is at the location, such as studying, developing software, advertising, playing tennis, swimming, attending an event such as a party or a concert, etc. The historical information can include how frequently the user engages in the activity, and/or how much the user enjoys the activity, e.g. user's affinity for the activity.

In step 2340, the processor can suggest the local activity to the first group of collocated users. The suggested local activity can be an area already occupied by at least one of the second group of collocated users, or can be a local activity within a walking distance from where the second group of users is located. That way, the users do not need to drive or take public transport. The suggested local activity can include fostering relationships between two users in the second group of collocated users such as by establishing business relationships or social relationships.

To collect historical information, the processor can determine an affinity for the local activity associated with each user in the first group of collocated users. To determine the affinity, the processor can receive text-based feedback from the users regarding the local activity and parse the text to identify keywords or phrases using known linguistic analysis. The processor can categorize the local activity by topics, and can determine the users' affinity to each topic. Based on the determined affinity, the processor can identify a second local activity occurring at a future date. For example, if the second local activity occurring at the future date can be categorized into a topic to which the first group of collocated users has high affinity, the processor can suggest the second local activity to the first group of collocated users. Otherwise, the processor can forgo suggesting the second local activity.

The processor can also automatically determine the affinity of each user in the first group of collocated users for the local activity. For example, the processor can determine a location of the local activity and a time of occurrence of the local activity. The processor can locate a device associated with each user in the first group of collocated users during the time of occurrence of the local activity. The device can be a personal device such as a cell phone, a watch, a hearing aid, a clothing chip, etc. The processor can determine a length of time the device associated with each user spent at the location of the local activity during the time of occurrence of the local activity.

The processor can adjust the affinity based on the length of time. For example, the longer the user stayed at the local activity, the processor can record the higher affinity. The less the user stayed at the local activity, the processor can record the lower affinity. In a more specific example, the processor can measure the affinity of the user by the percentage of time the user spent at the event. If the event lasts 2 hours, and the user spent 1 hour the event, the affinity of the user can be determined to be 50%. Based on the determined affinity, the processor can identify a second local activity occurring at a future date. For example, if the user has an affinity for a topic such as hip-hop music events, the processor can identify future events categorized under the topic hip-hop music.

When presenting the local activity, the processor can keep the style of the presentation consistent with the member app. The processor can determine a style of a suggestion for the local activity presented to the first group of collocated users. The style can include layout, location of pictures within the layout, content of pictures, font and size of text. The processor can generate a second suggestion for a second local activity in the determined style.

FIG. 24 is a flowchart of a method to enable a user to reserve a meeting room. The booking app can perform the steps listed in FIG. 24. In step 2400, the processor can receive an input describing a meeting including a number of attendants, a location of attendants, a meeting time, and a meeting topic. The input can be a natural language input, and the processor can interpret the natural language input to obtain information describing a meeting including a number of attendants, location of attendants, a meeting time, and a meeting topic.

In step 2410, the processor can determine meeting room requirements including a size of a meeting room and equipment associated with the meeting room based on the number of attendants, location of attendants and the meeting topic. For example, based on the location of the attendants, the processor can determine whether an attendant is remote. Upon determining that the attendant is remote, the processor can determine that the meeting room requirements include equipment configured to enable videoconferencing. In another example, the processor can determine that the attendants are collocated, and can suggest a meeting room close to the location of the attendants, to avoid attendants having to travel to a distant meeting room. That way, the processor can minimize traffic congestion and greenhouse gas emissions.

In step 2420, the processor can obtain available meeting rooms during the meeting time and the available meeting rooms' attributes including a size and equipment. In step 2430, the processor can compare the available meeting rooms' attributes to the meeting room requirements.

In step 2440, the processor can create a prioritized list based on the comparison between the available meeting rooms' attributes and the meeting room requirements. The entries at the top of the prioritized list reflect the available meeting rooms having the best matched to the meeting room requirements.

For example, to create a prioritized list the processor can obtain prior meeting rooms reserved by the user and prior topics associated with prior meeting rooms. The processor can determine a matching topic among the prior topics having best semantic match to the meeting topic. The processor can obtain equipment associated with a meeting having the matching topic. The processor can determine equipment associated with the meeting room to be same as the equipment associated with the meeting having the matching topic. In another example, when a user has previously reserved a meeting room, the processor can present a prioritized list of meeting rooms that have been most frequently used by the user.

In step 2450, the processor can provide the prioritized list to a user. Upon presenting the prioritized list, the processor can receive a meeting room selection from the user, and can reserve the selected meeting room.

Some of the users attending the meeting in person may have never been in the meeting room or in the building. To aid the users in finding the meeting room, the processor can create an augmented reality display of an environment surrounding the meeting room. The augmented reality display can include displaying directions to the meeting room, such as arrows indicating the desired movement direction, thereby enabling the user to navigate to the meeting room.

The processor can also inform the user of the surroundings of the meeting room. For example, the processor can create an augmented reality display of an environment surrounding the meeting room including displaying information associated with the surrounding environment. In a more specific example, the processor can obtain information about the user, such as user's interests, and can identify locations in the environment surrounding the meeting room that match the user's interests. The processor can provide the information about the identified locations to the user through an augmented reality display.

Some locations, such as non-reservable rooms, cannot be booked. The non-reservable rooms can be phone booths. The processor can monitor the current occupancy of the non-reservable rooms, in real time, using a sensor, such as a camera, a Wi-Fi sensor, and/or an IR sensor. The processor can inform the user of the availability of the non-reservable room based on the monitoring.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions can be performed by other elements in the same or differing networks, which can reduce the number of network elements. Alternatively, or additionally, network elements performing those functions can be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

I/We claim:

1. A method comprising:
reducing traffic congestion and greenhouse gas emissions by identifying a local activity relevant to a first group of collocated users, wherein reducing traffic congestion further comprises:
determining a second group of collocated users,
wherein the second group of collocated users includes the first group of collocated users,
wherein the second group of collocated users is frequently collocated at predictable times, and
wherein at least two users in the second group of collocated users are engaged in at least two different activities;
obtaining information associated with the at least two different activities and a historical information associated with each user in the first group of collocated users;
based on the information associated with the at least two different activities and the historical information, identifying the local activity relevant to the first group of collocated users; and
suggesting the local activity to the first group of collocated users.

2. The method of claim 1, wherein the obtaining information associated with the at least two different activities comprises:
obtaining a description of an offer provided by a first user in the first group of collocated users, and the description of a request associated with a second user in the first group of collocated users;
determining whether the offer matches the request; and
upon determining that the offer matches the request, providing the offer to the second user.

3. The method of claim 1, comprising:
determining an affinity for the local activity associated with each user in the first group of collocated users; and
based on the determined affinity, identifying a second local activity occurring at a future date.

4. The method of claim 1, comprising:
determining an affinity for the local activity associated with each user in the first group of collocated users by
determining a location of the local activity and a time of occurrence of the local activity,
locating a device associated with each user in the first group of collocated users during the time of occurrence,
determining a length of time the device associated with each user spent at the location of the local activity during the time of occurrence of the local activity, and
adjusting the affinity based on the length of time; and
based on the determined affinity, identifying a second local activity occurring at a future date.

5. The method of claim 1, comprising:
determining a style of a suggestion for the local activity presented to the first group of collocated users; and
generating a second suggestion for a second local activity in the determined style.

6. A system comprising:
one or more processors;
memory coupled to the one or more processors, wherein the memory includes instructions executable by the one or more processors to:
reduce traffic congestion and greenhouse gas emissions by identifying a local activity relevant to a first group of collocated users, wherein reducing traffic congestion further comprises:
determine a second group of collocated users,
wherein the second group of collocated users includes the first group of collocated users,
wherein the second group of collocated users is frequently collocated at predictable times, and
wherein at least two users in the second group of collocated users are engaged in at least two different activities;
obtain information associated with the at least two different activities and a historical information associated with each user in the first group of collocated users;
based on the information associated with the at least two different activities and the historical information, identify the local activity relevant to the first group of collocated users; and
suggest the local activity to the first group of collocated users.

7. The system of claim 6, wherein the instructions to obtain the information associated with the at least two different activities further comprise instructions to:
obtain a description of an offer provided by a first user in the first group of collocated users, and the description of a request associated with a second user in the first group of collocated users;
determine whether the offer matches the request; and
upon determining that the offer matches the request, provide the offer to the second user.

8. The system of claim 6, the instructions further comprising the instructions to:
determine an affinity for the local activity associated with each user in the first group of collocated users; and
based on the determined affinity, identify a second local activity occurring at a future date.

9. The system of claim 6, the instructions further comprising the instructions to:
determine an affinity for the local activity associated with each user in the first group of collocated users by
determining a location of the local activity and a time of occurrence of the local activity,
locating a device associated with each user in the first group of collocated users during the time of occurrence,
determining a length of time the device associated with each user spent at the location of the local activity during the time of occurrence of the local activity, and
adjusting the affinity based on the length of time; and
based on the determined affinity, identify a second local activity occurring at a future date.

10. The system of claim 6, the instructions further comprising the instructions to:
determine a style of a suggestion for the local activity presented to the first group of collocated users; and
generate a second suggestion for a second local activity in the determined style.

11. At least one non-transitory, computer-readable medium carrying instructions, which when executed by at least one data processing platform, performs a method of reserving/allocating space for a meeting of two or more people, the instructions comprising:
receiving an input describing a meeting including a number of attendants, a location of attendants, a meeting time, and a meeting topic;
determining meeting room requirements including a size of a meeting room and equipment associated with the meeting room based on the number of attendants, the location of attendants and the meeting topic;
obtaining available meeting rooms during the meeting time and attributes of the available meeting rooms,
wherein the attributes include a size of a particular meeting room and equipment available at a particular meeting room;
comparing the attributes of the available meeting rooms to the meeting room requirements;
creating a prioritized list based on the comparison between the attributes of the available meeting rooms and the meeting room requirements; and
providing the prioritized list to a user to permit the user to select a meeting room from the prioritized list.

12. The non-transitory, computer-readable medium of claim 11, comprising:
based on the location of attendants determining whether an attendant is remote; and
upon determining that the attendant is remote, determining that the meeting room requirements include equipment configured to enable videoconferencing.

13. The non-transitory, computer-readable medium of claim 11, comprising:
obtaining prior meeting rooms reserved by the user and prior topics associated with prior meeting rooms;
determining a matching topic among the prior topics having best semantic match to the meeting topic;
obtaining equipment associated with a meeting having the matching topic; and
determining the equipment associated with the meeting room to be same as the equipment associated with the meeting having the matching topic.

14. The non-transitory, computer-readable medium of claim 11, wherein the input comprises a natural language input, the method comprising:
interpreting the natural language input to obtain the input describing the meeting including the number of attendants, the location of attendants, the meeting time, and the meeting topic.

15. The non-transitory, computer-readable medium of claim 11, comprising:
creating an augmented reality display of an environment surrounding the meeting room including displaying directions to the meeting room, thereby enabling the user to navigate to the meeting room.

16. The non-transitory, computer-readable medium of claim 11, comprising:
creating an augmented reality display of an environment surrounding the meeting room including displaying information associated with the environment surrounding the meeting room.

17. The non-transitory, computer-readable medium of claim 11, comprising:
monitoring a non-reservable room occupancy using a sensor; and
informing the user of availability of the non-reservable room based on the monitoring.

18. A system comprising:
one or more processors;
memory coupled to the one or more processors, wherein the memory includes instructions executable by the one or more processors to:
receiving an input describing a meeting including a number of attendants, a location of attendants, a meeting time, and a meeting topic;
determining meeting room requirements including a size of a meeting room and equipment associated with the meeting room based on the number of attendants, the location of attendants and the meeting topic;
obtaining available meeting rooms during the meeting time and available meeting rooms' attributes including a size and equipment;
comparing the available meeting rooms' attributes to the meeting room requirements;
creating a prioritized list based on the comparison between the available meeting rooms' attributes and the meeting room requirements; and
providing the prioritized list to a user.

19. The system of claim 18, the instructions further comprising the instructions to:
based on the location of attendants determine whether an attendant is remote; and
upon determining that the attendant is remote, determine that the meeting room requirements include equipment configured to enable videoconferencing.

20. The system of claim 18, the instructions further comprising the instructions to:
obtain prior meeting rooms reserved by the user and prior topics associated with the prior meeting rooms;
determine a matching topic among the prior topics having best semantic match to the meeting topic;
obtain equipment associated with a meeting having the matching topic; and
determine the equipment associated with the meeting room to be same as the equipment associated with the meeting having the matching topic.
